(19) United States
(12) Patent Application Publication
(10) Pub. No.: US 2009/0327052 A1
(43) Pub. Date: Dec. 31, 2009

(54) INTERACTIVE ORGANIZATIONAL INSTRUCTION SYSTEM

(76) Inventors: Brian D. Wong, Seattle, WA (US); Lawrence R. McEvoy, II, Colorado Springs, CO (US)

Correspondence Address: DAVIS WRIGHT TREMAINE, LLP/Seattle, 1201 Third Avenue, Suite 2200, SEATTLE, WA, 98101-3045, US

(21) Appl. No.: 12/165,393

(22) Filed: Jun. 30, 2008

(51) Int. Cl. G06Q 10/00

(52) U.S. Cl. 705/11

(57) ABSTRACT

A system for instructing a group of participants to function individually within an organization having a functional purpose. The system teaches four lifetime leadership lessons which include (1) adopting a set of universal attributes of a trusted colleague, (2) finding common ground as a community of trusted colleagues, (3) having conversations the participants need to have, the way they need to have them, and (4) making a correct, unifying “diagnosis” before starting “treatment” (also known as “seeing the whole elephant”). Beyond being taught these lessons, the participants are enabled to apply the lessons to solve any problem, in any part of the organization. Further, organizational change can be accelerated by these participants when they teach one or more of the four lessons to others in the organization.

### BACKGROUND OF THE INVENTION

1. Field of the Invention

The present invention is directed generally to an instructional system for improving an organization and more particularly to an instructional system that instructs a group of participants to improve the organization by improving their own individual behavior within the organization.

2. Description of the Related Art

While physicians and other heath care professionals are often outstanding at practicing medicine, many experience difficulty practicing within an organization. In organizations, physicians sometimes isolate themselves making teamwork and the formation of functioning teams difficult.

Numerous studies have demonstrated the pervasiveness of disruptive physician behavior in virtually every medical community. In one large study conducted by VHA, Rosenstein, Russell, and Lauve surveyed over 2,500 respondents in 142 healthcare institutions across the country. The study determined over 90% of respondents had either witnessed or experienced an act of physician disruptive behavior that included disrespect, berating, abusive language, or condescension. The impact of this behavior was profound on nursing morale and retention, compounding an already acute national nursing shortage. Further, the Joint Commission on Accreditation of Healthcare Organizations (“JCAHO”) is in the process of proposing a requirement that all hospitals have a written code of conduct for physicians.

In recent years, an increasing number of physicians are beginning to grasp that physician disruptive behavior is a serious problem in their respective medical communities. Further, many have begun to reach a point where they believe something must be done about it, and are willing to begin with their own attitudes, actions, and behaviors. The challenge to date has been framing this issue for physicians in a way that allows them to have an epiphany, (i.e., an “aha” moment of recognition) with respect to the fact that the problem is serious, pervasive, present in their own back yard, and has been allowed to progress to a point where it can no longer be tolerated.

Unfortunately, many conventional approaches directed toward effecting organizational improvement do not focus on disruptive or undesirable behavior. Further, many approaches fail to provide an “ah-ha” moment or fail to leverage the “ah-ha” moment properly. Additionally, few methods focus on communication skills as a means of facilitating and leveraging behavior improvement. The present application provides these and other advantages as will be apparent from the following detailed description and accompanying figures.

### BRIEF DESCRIPTION OF THE SEVERAL VIEWS OF THE DRAWING(S)

FIG. 1 is a flow diagram of an exemplary embodiment of an interactive organizational instruction system constructed in accordance with the present invention.

FIG. 2 is an illustration of a hierarchy for individual and organizational alignment.

FIG. 3 is an illustration of a profitability cycle based on the hierarchy of individual and organizational alignment illustrated in FIG. 2.

FIG. 4 is a flow diagram of a method performed by a first module of the system of FIG. 1.

FIG. 5 is a flow diagram of a method performed by a second module of the system of FIG. 1

FIG. 6 is an illustration of an “eye chart” prepared during the second module of FIG. 5.

FIG. 7A is an example of a completed give/get grid representing a declaration of interdependence prepared during the second module of FIG. 5.

FIG. 7B is an example of a blank give/get grid to be completed during the second module of FIG. 5 and used to create the declaration of interdependence of FIG. 7A.

FIG. 8 is a chart depicting exemplary responses provided to the questions (1) “what do the participants want,” and (2) and “what are the participants willing to give to get what they want” posed during the second module of FIG. 5.

FIG. 9A is a flow diagram of a first method that may be performed by a third module of the system of FIG. 1.

FIG. 9B is a flow diagram of a second method that may be performed by the third module of the system of FIG. 1.

FIG. 10 is an illustration of a dialogue model created by Patterson, K., et al., and published in “Crucial Conversations.”

FIG. 11 is a modified version of the dialogue model of FIG. 10 modified to include labels identifying an ideal state, a disaster state, universal attributes, and graffiti behaviors.

FIG. 12 is a table depicting possible responses to noxious and healthy stimuli.

FIG. 13 is a flow diagram of a method performed by both a fourth module and a fifth module of the system of FIG. 1.

FIG. 14A is a flow diagram of a method performed by the fourth module including the method of FIG. 13.

FIG. 14B is a flow diagram of a method performed by the fifth module including the method of FIG. 13.

FIG. 15 is an illustration of a cycle for use with an alternate embodiment of the interactive organizational instruction system of FIG. 1.

FIG. 16 is an illustration of a “root cause” analysis depicting mistrust as a root cause of many if not all of the problems in healthcare (the reasons supporting mistrust as a root cause are provided on the left-hand side of the illustration), and depicting mistrust as a barrier to achieving one or more desired results (listed on the right-hand side).

FIG. 17 is an illustration depicting trust as a root cause or solution underpinning the lessons of the cycle of FIG. 15 (listed on the left-hand side) and therefore as a solution to many if not all of the problems in healthcare, and depicting trust as an accelerator to achieving one or more desired results (listed on the right-hand side).

FIG. 18 is an exemplary worksheet configured to help participants frame important issues of a crucial conversation.

### DETAILED DESCRIPTION OF THE INVENTION

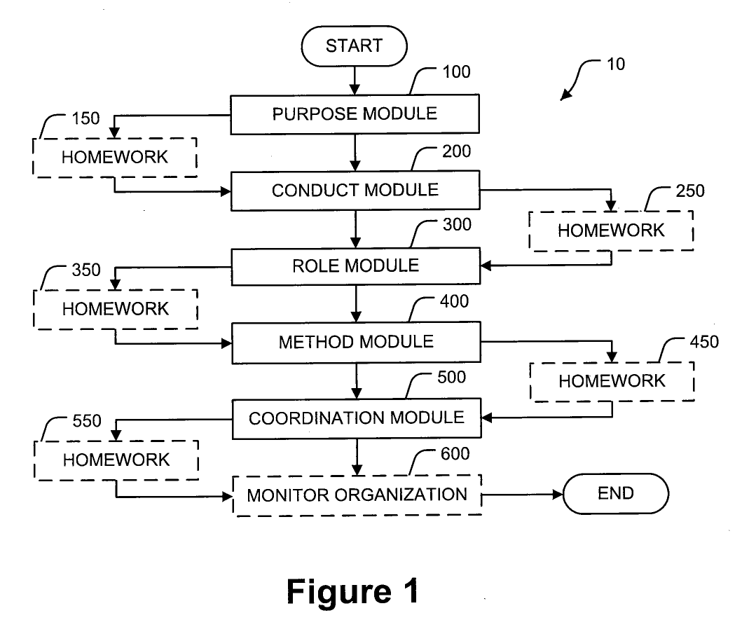

Referring to FIG. 1, aspects of the present invention relate to an interactive organizational instruction system 10 for instructing or teaching personnel of an organization, such as a medical organization, that has a functional purpose, such as the treatment of patients, the production of one or more products, provision of one or more services, or the like. While the system 10 is described with respect to a single exemplary organization, those of ordinary skill appreciate that the participants may include members of different organizations, members of multiple organizations, and the like. As used herein, the term “medical organization” may refer to a clinic, hospital, health system, health plan, and the like. An organization may also include any department (or combination of departments) within a clinic, hospital, health system, health plan, and the like.

Members of the organization may include employees, such as persons who treat or work directly with patients, such as physicians, nurses, technicians, and the like, as well as persons who provide administrative services, support services, and the like. In some cases, members may include persons not employed by the medical organization, including independent contractors, volunteers, patients, and family members.

While the system 10 is generally described with respect to a medical organization and the members are generally discussed as being physicians, those of ordinary skill appreciate that the system 10 may be used with other organizations, such as law firms, engineering firms, financial institutions, manufacturing facilities, government agencies, service providers, and the like, and the members of such organizations may include anyone employed at the organizations, including private contractors, consultants, volunteers, and the like. Further, the system 10 may be used by non-profit and volunteer organizations and the members thereof may include employees as well as volunteers at the organization.

The system 10 may be characterized as including five discrete modules 100, 200, 300, 400, and 500. Each module may be presented to one or more participants by one or more presenters. The term “participant” is used to refer to the members of the organization attending the presentation of a module. Preferably, each module 100, 200, 300, 400, and 500 is presented to a group or plurality of participants. However, the same group of participants need not complete all of the modules 100, 200, 300, 400, and 500 together.

The term “present” as used herein with respect to the modules 100, 200, 300, 400, and 500 refers to both a conventional presentation of materials (e.g., in a conventional lecture format) as well as an interactive presentation of materials and concepts, such as individual exercises, group exercises, and the like. The term “exercise” encompasses participation in discussions, individual activities, group activities, and the like as well as making commitments such as taking an oath, making promises, agreeing to compacts, and the like.

The presenter(s) may present each module on a different day. Alternatively, one or more of the modules 100, 200, 300, 400, and 500 may be presented during a single day. The modules 100, 200, 300, 400, and 500 may be presented over a period of about two consecutive days to about four or more consecutive days. Alternatively, the modules may be spaced apart by several days or months. By way of non-limiting example, a module may be offered every three months. For example, the first module 100 may be offered in January, the second module 200 may be offered in April, the third module 300 may be offered in July, the fourth module 400 may be offered in October, and the fifth module 500 may be offered the following January.

Each of the modules 100, 200, 300, 400, and 500 may be presented to all of the members of an organization or a portion thereof. For example, the modules 100, 200, 300, 400, and 500 may be presented to all of the physicals or a portion thereof working at or affiliated with a medical organization. The modules 100, 200, 300, 400, and 500 may be presented to the members of a single medical organization or to a mixed group of members from two or more organizations, such as medical organizations.

After each of the modules 100, 200, 300, 400, and 500, an optional homework assignment 150, 250, 350, 450, and 550, respectively, may be assigned to one or more of the participants. The optional homework assignments 150, 250, 350, 450, and 550 may relate to one or more of the modules that precedes the homework assignment. Specifically, each of the homework assignments 150, 250, 350, 450, and 550 may include exercises directed toward implementing the module that immediate preceding it.

Optionally, the system 10 may include a monitoring function 600 in which the presenter(s) or other appropriately trained individuals monitor the organization to determine how well it has implemented the lessons of modules 100, 200, 300, 400, and 500. By way of example, while performing the monitoring function 600, the presenter(s) of the modules 100, 200, 300, 400, and 500 may monitor the participants' and/or the organization's progress to ensure the lessons taught in the modules are being implemented properly. During execution of the monitoring function 600, it may determine that one or more members of the medical organization need(s) to repeat one or more of the modules 100, 200, 300, 400, and 500. Optionally, monitoring may occur after each of the modules 100, 200, 300, 400, and 500.

Many physicians and other medical professionals are familiar with a teaching technique referred to as “see one, do one, teach one.” This approach is commonly used in medical schools as well as medical facilities (e.g., clinics, hospitals, and the like) to teach medical procedures. A person is first shown how to perform a medical procedure. Then, that person is asked to perform the medical procedure. Finally, after mastering the medical procedure, the person is called upon to teach the medical procedure to another. Aspects of the inventive system 10 may take advantage of this paradigm to teach non-medical procedures and behaviors to medical professionals. The objective of the “see one, do one, teach one” approach is to accelerate learning, application and mastery of the inventive system 10.

The “see one” occurs during the didactic presentation and demonstration of the modules 100, 200, 300, 400, and 500. The “do one” occurs when the participants are asked to practice aspects of each module in individual and small group exercises and after some of the optional homework assignments are given. The “do one” may also occur when the participants return back to the organization and implement the lessons learned during the modules. For example, the “do one” may occur when the participants work toward completing the homework assignments 150, 250, 350, 450, and 550 following modules 100, 200, 300, 400, and 500, respectively. The “teach one” may occur by example as the participants return to the organization and implement the lessons learned (e.g., by working on homework assignments 150, 250, 350, 450, and 550). Alternatively, the “teach one” may occur after a participant has mastered the lessons of the modules 100, 200, 300, 400, and 500. Such a participant may be tasked with teaching others within the organization. For example, during block 600, participants who have mastered the lessons of one or more of the modules 100, 200, 300, 400, and 500 may be instructed to teach the lessons mastered to others within the organization.

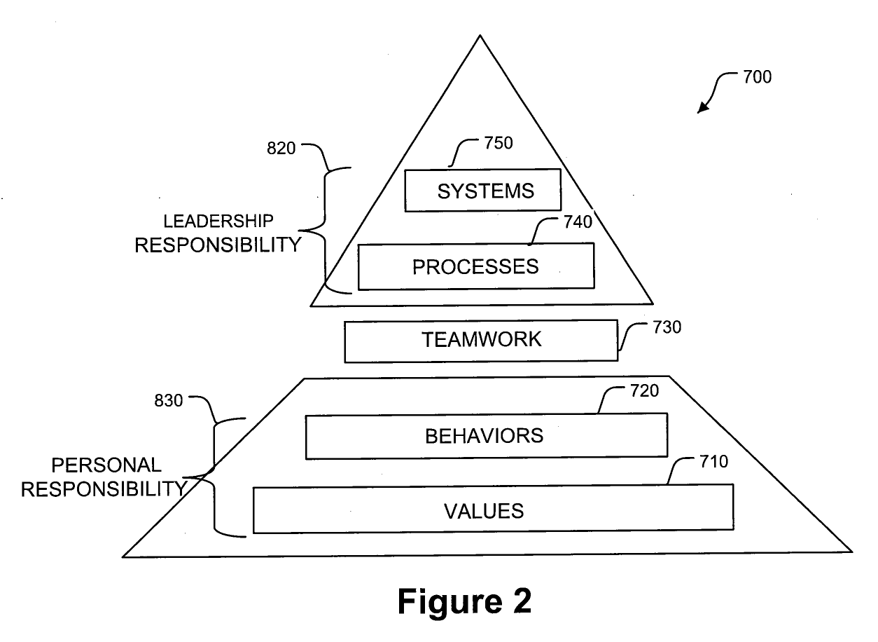

Referring to FIG. 2, aspects of the modules 100, 200, 300, 400, and 500 may be conceptualized as corresponding to tiers of a pyramid 700. The pyramid 700 has the following five tiers listed from the base of the pyramid to its top: values 710, behaviors 720, teamwork 730, processes 740, and systems 750. The content of the five tiers 710, 720, 730, 740, and 750 may be focused on profitable values, profitable behaviors, profitable teamwork, profitable processes, and profitable systems, respectively.

Alternatively, aspects of the modules 100, 200, 300, 400, and 500 may be conceptualized as corresponding to tiers of a pyramid (not shown) that includes six tiers, each tier corresponding to one of the following levels of clarity:
1. Clarity of conduct
2. Clarity of purpose
3. Clarity of role
4. Clarity of conversation
5. Clarity of method
6. Clarity of structure

In the context of a medical organization, the term “profitable” means an activity is beneficial, useful, advantageous, valuable, helpful, and/or yields advantageous returns or results. The modules 100, 200, 300, 400, and 500 may correspond to the values tier 710, behaviors tier 720, teamwork tier 730, processes tier 740, and systems tier 750, respectively.

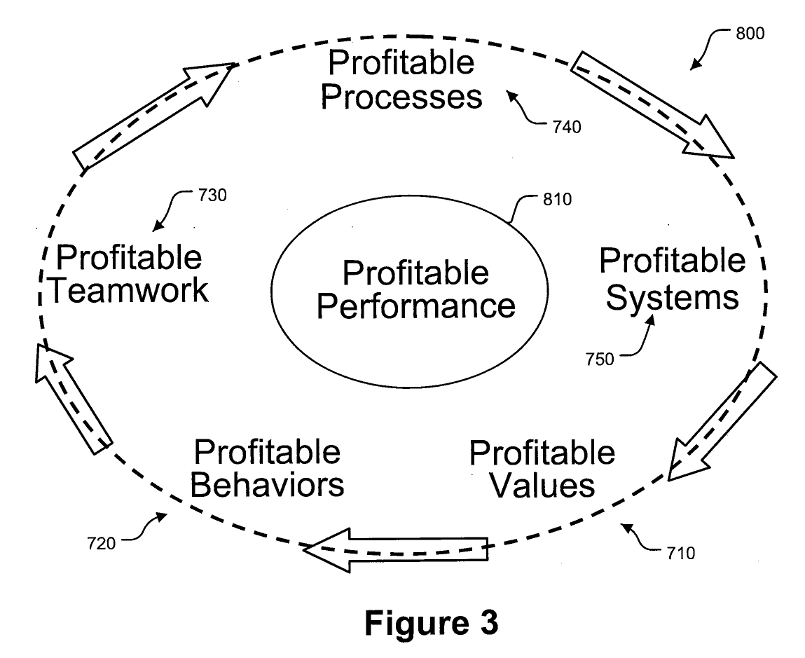

Referring to FIG. 3, each of the modules 100, 200, 300, 400, and 500 and thus, the five tiers 710, 720, 730, 740, and 750 of the pyramid 700 may be conceptualized as corresponding to a portion of a cycle 800 referred to as a profitability cycle. In essence, instead of viewing each of the five tiers 710, 720, 730, 740, and 750 of the pyramid 700 of FIG. 2 in a linear fashion, which tends to give the impression that each tier is traversed only once and not revisited, the five tiers 710, 720, 730, 740, and 750 may be organized as portions of a continuum or the cycle 800 in which the tiers may be revisited. Further, like the water cycle, each portion of the cycle 800 feeds into the next.

The water cycle is a concept typically taught in grade school that is simple, timeless, classic, immutable, and powerful. Further, the water cycle illustrates a simple cycle for a renewable natural resource that sustains not just human life, but all life on our planet. In other words, the water cycle is essential. Further, the processes of the water cycle, evaporation, condensation, precipitation, and run-off are substantially equally important and all occur in balance and in sequence globally. The cycle 800 may be considered a “renewable natural resource” for an organization that is capable of regenerating itself and sustaining everyone in the organization. Further, each of the portions of the cycle 800 may be viewed as substantially equally important.

In the cycle 800 illustrated in FIG. 3, the tiers 710, 720, 730, 740, and 750 are arranged in the same order in which they appear in pyramid 700 from the bottom tier to the top tier. However, those of ordinary skill in the art understand that the order of the tiers 710, 720, 730, 740, and 750 in the cycle 800 may vary and one or more of the tiers may be omitted during a particular traversal of the cycle. Traversing and repeating the cycle 800 drives an organization to a level of profitable performance 810, in which all of the tiers 710, 720, 730, 740, and 750 are practiced by a sufficient number of the members of the organization.

Returning to FIG. 2, the processes tier 740 and the systems tier 750 may be grouped together by a bracket 820 indicating these tiers represent leadership responsibilities. A bracket 830 may group the values tier 710 and the behaviors tier 720 together indicating these tiers represent individual responsibilities. The teamwork tier 730 is viewed a bridge between leadership responsibilities and individual responsibilities.

Many organizational instructional systems focus on the top two tiers: the processes tier 740 and the systems tier 750. In contrast, aspects of the system 10 focus on the bottom three tiers: the values tier 710, the behaviors tier 720, and the teamwork tier 730. These layers, which focus on individual behavior, are considered by many to be the most difficult to teach. Particular aspects of the system 10 focus on the elimination of negative behaviors because such behaviors may have a negative impact on the organization that is far greater than positive impact derived from positive behaviors.

While the contents of each module are described as occurring in a particular order, those of ordinary skill in the art appreciate that the invention is not limited to the order described. In particular, it may be desirable to arrange or order the content presented within a module based on the needs of a particular organization, the presentation style of the presenter(s), and the like. Further, the content of a module may be arranged based on one or more time constraints. Additionally, it may be beneficial to switch back and forth between concepts (and thus, modules). In this manner, the participants are introduced to a concept and allowed to think about that concept before the concept is presented in its entirety. Switching back and forth between two or more concepts may also help demonstrate a degree of interdependence between the concepts.

Because the system 10 is used by a group of participants, several methods may be used to obtain results for the various activities and exercises provided in the methods (described below) performed during the modules 100, 200, 300, 400, and 500. Generally speaking, each exercise is completed by the group as a whole and a single group response is elicited. Two non-limiting methods that are well-known in the art, “The Wisdom of Crowds” method and the division into small groups method, are described herein for illustrative purposes. However, those of ordinary skill in the art appreciate that other methods may be used and are within the scope of the present teachings. Further, more than one technique may be used to obtain the group response.

“The Wisdom of Crowds” method involves presenting a particular question to the group and eliciting a response therefrom. The majority response is considered to be the response of the entire group. The response may be obtained by asking the group to “shout out” responses, vote on a particular response by raising their hands or applauding, and the like.

The division into small groups method includes dividing the group into smaller groups (e.g., groups of 3-5 participants). Then, all of the small groups are asked the same question. Each of the small groups prepares a response to the question and shares that response with the other groups. Then, “The Wisdom of Crowds” method may be used to consolidate or otherwise consider the small group responses for the purposes of preparing a representative response for the entire group. Optionally, before the small group considers the question, each of the participants may be asked to prepare an individual response that is subsequently shared with the remainder of the small group. The small group may then consolidate or otherwise consider the individual responses when preparing the small group response. The division into small groups method is a highly efficient, effective, and democratic way for a large group to formulate a consensus opinion to a question while every participant is provided ample opportunity for their individual voice to be heard.

Generally speaking, the division into small groups method is preferred because it is more likely to engage nearly all of the participants. However, this method generally requires more time to perform than “The Wisdom of Crowds” method. Therefore, the size of the audience, the amount of time available, and the level of participation exhibited by the participants may determine which method is used.

After receiving a response to a question from the entire group or the small groups, the presenter(s) may display the response or responses to the participants thereof. By way of a non-limiting example, the responses may be written down or otherwise recorded within the view of the participants. For example, the responses may be written on a whiteboard, chalkboard, transparency, and the like or typed into a software program (such as PowerPoint) for projection onto a screen or monitor viewable by the group.

### Module 100

As mentioned above, aspects of the module 100 may be viewed as corresponding to the profitable values tier 710 (see FIG. 2). Profitable values are defined as a common set of values shared by everyone in the organization. People in the organization who share profitable values also share a common vision and purpose. The first module 100 is designed to instill clarity of purpose.

The module 100 may begin with an introduction to the tiers 710, 720, 730, 740, and 750 of the pyramid 700 (see FIG. 2) and the profitability cycle 800 (see FIG. 3) for the purposes of providing an overview of the modules 100, 200, 300, 400, and 500 and their interrelationships to the participants.

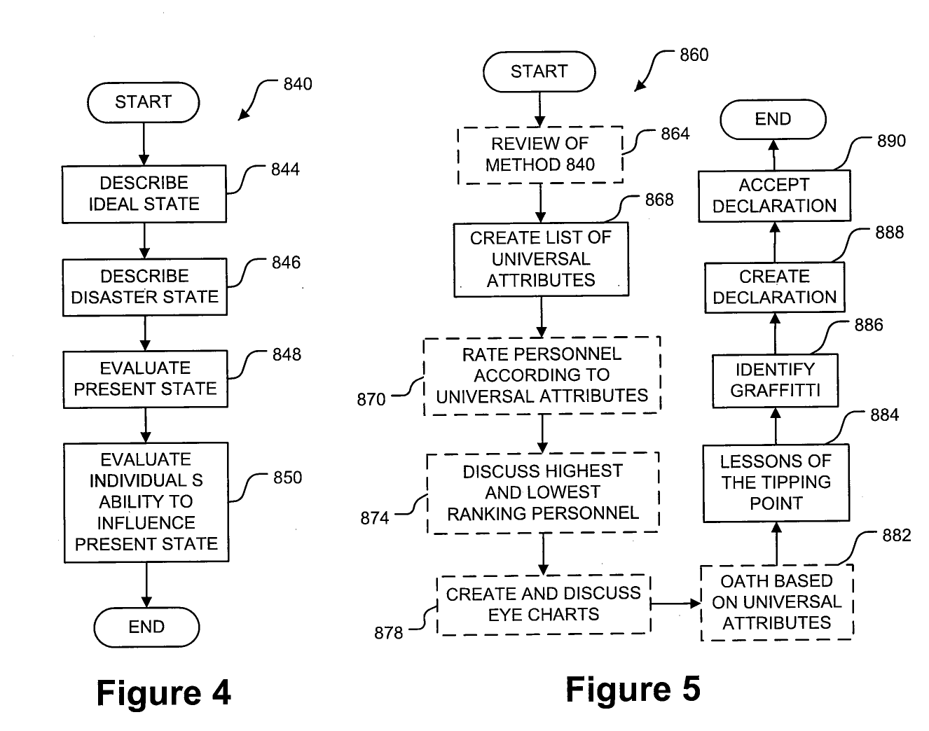

Referring to FIG. 4, the module 100 may perform a method 840. In blocks 844-848, the participants are asked to participate in an exercise in which the present state of the organization is evaluated against an ideal state and a disaster state. Either “The Wisdom of Crowds” method or the division into small groups method may be used in each of the blocks 844-848 to obtain the results described below.

In block 844, the participants are asked to describe the ideal state. The ideal state may be the ideal state of the organization or a hypothetical ideal organization. The ideal state is a state in which the organization is able to at least partially perform its functional purpose. In other words, the organization is not completely dysfunctional. In particular embodiments, the ideal state may be a state in which the organization is able to optimally perform its functional purpose. In such embodiments, in the ideal state, the organization has successfully eliminated its dysfunctions. The ideal state represents a state that is preferable to the participants over the present state of the organization.

If the participants are from more than one organization, a hypothetical organization may be used to describe the ideal state. However, this may not be necessary because participants from different organizations typically describe the same “ideal state.” Therefore, the ideal state is generally not organization dependent. A non-limiting example of a description of the ideal state prepared by the group as a whole may include the following:
1. Peaceful
2. Enthusiastic
3. Open & honest communication
4. Medical staff engaged with each other, other staff, and administration
5. A physical plant with more capabilities and financially able
6. A desired place to work and practice (destination of choice)
7. Improved respect and trust among and between all providers
8. A compelling, long range vision that informs each participant how he/she fits into the vision
9. True collegiality
10. Sincere focus on patients
11. Known for compassion, competence and cohesion
12. Decreased turnover in physicians, nursing and administration
13. Expand our horizons beyond the county to our region
14. Open communication outside the walls of this medical center
15. Take the high road regarding the new competing hospital

In next block 846, the participants are asked to describe the disaster state. The disaster state may be the disaster state of the organization or a hypothetical dysfunctional organization. The disaster state is a state in which the organization is less able to at least partially perform its functional purpose than when in the ideal state. In other words, in the disaster state, the organization is closer to being completely dysfunctional than it is in the ideal state. Further, the disaster state represents a state that is less preferable to the participants than the present state of the organization.

If the participants are from more than one organization, a hypothetical organization may be used to describe the disaster state. However, this may not be necessary because participants from different organizations typically describe the same “disaster state.” Therefore, the disaster state is generally not organization dependent. A non-limiting example of a description of the disaster state prepared by the group as a whole may include the following:
1. Triumph of self over community
2. Two competing full-service hospitals; resultant loss of market share, volume and income for the organization and/or its members
   Becoming the “county hospital”
   Loss of community support
   Possible closure of the organization
   Hospital-physician rivalries become a way of life
   Loss of hope as “the second tier”
3. Loss of quality physicians & staff (“brain drain”)
   Physicians cry, “Uncle!”
   Makes physicians want to leave the profession

While block 844 (describing the ideal state) is depicted as occurring before block 846 (describing the disaster state), those of ordinary skill appreciate that the method 840 is not limited to this ordering and block 846 could occur before block 844.

In next block 848, the participants are asked to evaluate the present state of the organization against the ideal state and the disaster state. Optionally, a visual depiction of a linear scale labeled “ideal” at one end (i.e., one extremum) and “disaster” at the other end (i.e., the other extremum) may be used. The participants may indicate on the scale where they believe their organization belongs. In alternate embodiments, blocks 844 and 846 may be skipped and instead, in block 848, the participants may be asked, “on a scale ranging from “ideal” to “disaster,” where their organization currently falls?”

As a general rule, an organization in which its members and/or customers/clients are experiencing dissatisfaction will be evaluated as closer to the disaster state than the ideal state. This exercise may illustrate to the participants the need for change in the organization. In other words, participants from organizations having dissatisfied members, after block 848, will generally agree those organizations need to change. However, while this recognition is useful, it does little to recognize what needs to change and how that change might be effected.

The “disaster state” and the “current state” exercises may be consolidated into a consolidated exercise that asks the participants to list “current barriers to the ideal state.” A non-limiting example of responses to this question may include the following:
1. Physicians not yet on board with the Universal Attributes
2. Lack of project management
3. Time and workload issues
4. Fragmented communications
5. Less face time with each other
6. Body language, non-verbal behavior
7. “flashbacks”
8. Our own strengths can get in the way
9. Personal agendas
10. Geographic dispersion
11. Ineffective/redundant meetings
12. Lots of new employees
13. Our relationship with the union
14. Old habits
15. Fear
16. Poor communication skills
17. “they”>“we”
18. Inequity among us
19. Some get more attention than others
20. Role isolation/autonomy
21. Making the time
22. Clinical vs. non-clinical thinking
23. Lack of inclusion
24. We're treating each other better, but it may not be translating to the entire organization

In block 850, the participants evaluate an individual's ability to influence the present state of the organization. In particular, how an individual's behavior affects those around him/her and the organization as a whole. Block 850 allows the participants to recognize they have control over the present state of the organization. A useful exercise that may be conducted in block 850 includes using division into small groups, wisdom of crowds, and the like to evaluate a present momentum of the organization, as opposed to the present state of the organization. The present momentum is the direction in which the organization is moving, which may be toward the ideal state or toward the disaster state.

By way of a non-limiting example, the current momentum may be evaluated by asking the participants to write down (or think of) something happening at the organization that is moving the organization toward the ideal state and something happening at the organization that is moving the organization toward the disaster state. These individual responses may be shared with members of a small group and an agreed upon list of items moving the organization toward each of the ideal state and the disaster state prepared. The agreed upon list may include a single item moving the organization toward the ideal state and a single item moving the organization toward the disaster state. Then, the lists prepared by the small groups may be used by the entire group to create a pair of lists, one listing items moving the organization toward the ideal state and another listing items moving the organization toward the disaster state.

After creating the pair of lists, the number of items on those lists attributable to individual behavior may be identified. These items represent things influencing the present state that are under the direct control of the participants. Block 850 allows the participants to recognize the effect of individual behavior on the present state of the organization and thereby the ability of each participant to influence the present state with his/her own behavior. In other words, the participants recognize their control over the present state of the organization. This recognition may represent a moment of discovery or an “ah-ha” moment for the participants.

In summary, the module 100 may include two exercises. First, an exercise aimed at locating the present state of the organization somewhere between the ideal state and the disaster state. Second, creating a list of individual behaviors that influence the present state toward the ideal state and a list of individual behaviors that influence the present state toward the disaster state.

The module 100 also produces one or more deliverables. The first deliverable may include descriptions of the ideal state and the disaster state. The second deliverable may include a visual depiction of the location of the present state of the organization between the ideal state and the disaster state. Another deliverable may include the lists of individual behaviors that influence the present state toward the ideal state and the disaster state.

Returning to FIG. 1, optionally, in block 150, the participants may be given homework to complete before advancing to the second module 200. As is apparent to those of ordinary skill, the first module 100 helps the participants obtain awareness of the affect of their behavior on the present momentum of the organization. Therefore, the homework assigned should be geared toward reinforcing the connection between behavior and the present state, the present momentum, and the like. For example, the participants could be asked to list behaviors observed, behaviors in which they engaged, and the like that moved the present state of the organization toward the ideal state and the disaster state. The participants could also be asked to determine which type of behaviors are dominant, those behaviors moving the organization toward the ideal state or those behaviors moving the organization toward the disaster state.

Depending on the particular implementation of the first module 100, the first day may end at this point. This allows the participants to reflect on the materials presented before beginning the second module 200. This may also allow the participants to return to the organization and complete their homework assignments (block 150). Further, the participants can report back to the presenter(s) regarding the effectiveness of the lessons learned during the first module 100.

### Module 200

Aspects of the second module 200 may be viewed as corresponding to the profitable behaviors tier 720 of the pyramid 700 (see FIG. 2). The second module 200 is structured around defining profitable behaviors and promoting profitable behaviors amongst the participants. Profitable behaviors may be defined as a single code of conduct for everyone regardless of rank, status, and position. The second module 200 instills clarity of conduct. Referring to FIG. 5, the module 200 may perform a method 860. Optionally in block 864, it may be beneficial to begin the method 860 with a review of materials presented in the first module 100 (e.g., a review of the method 840).

In block 868, using any of the methods described above (e.g., wisdom of crowds, division into small groups, etc.), the group of participants is asked to imagine a best colleague and create a list of attributes (collectively referred to as “universal attributes”) that could be used to describe positive aspects of this person. The best colleague is a colleague with whom the participants enjoy working, respect, prefer to turn to in a crisis, and the like.

The term “universal” is used herein to refer to an item or a list of items identified by the group and accepted by a majority portion of the group. In other words, if the group is asked to describe something, the “universal” description of that thing is a description created by the group that the majority of the group agrees describes the thing. The list of universal attributes is a list of desirable behaviors that the majority of the group agrees describe a “best colleague.”

By way of non-limiting example, a list of universal attributes may include the following items:
1. Responsive to my concerns;
2. Treats me with respect;
3. Listens well; can be approached with a different opinion;
4. Compassionate;
5. Stays calm under pressure;
6. Positive attitude;
7. Team and patient focused;
8. Takes time to teach and to learn;
9. Works hard and carries a fair share of the load; and
10. Good steward of scarce resources.

Then, in block 870, the participants are asked to examine the members of the organization (e.g., coworkers) and using these universal attributes, identify a top “X” number of members (“A” players) and a bottom “Y” number of members (“D” players). Generally speaking, the best members will exhibit most to all of the universal attributes while the worst members will exhibit few to none of the universal attributes.

In block 874, the impact of “A” players and “D” players on the organization is explored. Scientific evidence demonstrating that a few bad apples really do spoil the barrel may be presented to the group. For example, the results of a study conducted by the “Rodney King” Commission may be presented. That study examined Los Angeles Police Department records of 8500 Police Officers for the years 1986 to 1990 and found that 3% of officers were responsible for 37% of all complaints of excessive force or improper tactics.

Optionally, in block 874, one or more of the following list of items may be discussed with respect to “A” players, “D” players, and average players:
1. Psychic Ownership—Attitude;
2. Discretionary effort;
3. Attracting/keeping the best people;
4. Openness and flexibility to change;
5. General grief and aggravation;
6. Complaints about the players;
7. Impact on collaboration and teamwork;
8. A blame free culture;
9. Sentinel events/legal liability; and
10. An environment of safe, quality care.
   The general consensus of the group is typically that “A” players (i.e., members exhibiting most, if not all, of the universal attributes) score or are rated higher with respect to the above items than the average player and “D” players (i.e., members exhibiting few, if any, of the universal attributes).

In block 874, the “A” players and “D” players may be scored with respect to each of the universal attributes and the differences in the scores noted. The participants are asked to observe how quickly they were able to identify their “A” players and “D” players. Generally, the participants are surprised to discover how quickly such people are identified and how quickly the participants agree on who is an “A” player and who is a “D” player. In other words, the criteria is at least somewhat objective, not varying between individuals.

The participants may be asked “whether the universal attributes accurately captured the essence of their opinions?” In other words, can the universal attributes alone be used to identify who is an “A” player and who is a “D” player? Generally, a majority portion of the participants will agree the universal attributes are effective at identifying who is an “A” player and who is a “D” player. In sum, the participants agree the list of universal attributes, which is itself typically substantially the same for all participants, can be used to objectively evaluate members of an organization (e.g., identify “A” players and “D” players).

In block 878, each participant may be asked to perform a self-assessment in which he/she rates himself/herself with respect to each of the universal attributes. The self-assessment may be shared with another participant and discussed. By way of a non-limiting example, the discussion may include a discussion of each participant's strengths, struggles, how those struggles “get in the way,” and the like. Then, the participants may select an area for self-improvement upon which they can work in homework 250 (see FIG. 1).

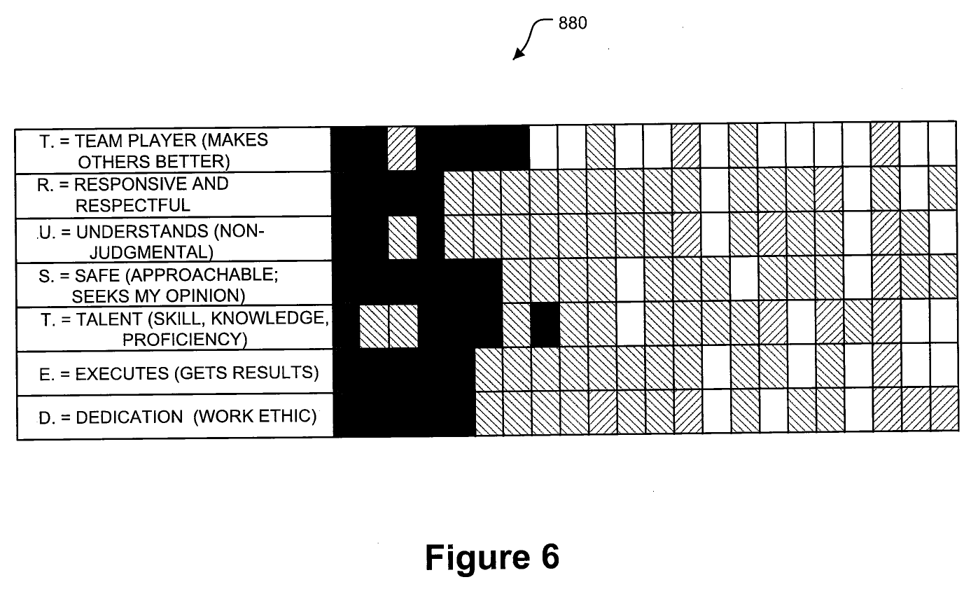

In block 878, the participants may be asked to rate (or diagnose) an entity (e.g., another member, a department within the organization, the entire organization, etc.) with respect to the universal attributes. Optionally, the rating may be in response to a particular question (e.g., “what is the typical response exhibited by the entity when confronted with change or any organizational efforts to effect a change”). The participants may be asked to rate individual physicians, leaders, staff members, medical departments, hospital departments, and combinations thereof. Those ratings may be combined to form an “eye chart” 880 depicted in FIG. 6.

In “eye chart” 880, each row corresponds to one of the universal attributes and each column corresponds to a member of the organization. At the intersections of the rows and columns an indicator of the rating that member received is provided. By way of example, a black box corresponds to the lowest rating possible and a white box corresponds to the highest rating possible. The cross-hatched boxes correspond to ratings between the highest and the lowest. The participants are given the opportunity to view the “eye chart” 880 and thereby quickly identify where the organization stands with respect to the universal attributes. In other words, the number of members exhibiting most of the universal attributes appear on the far right and have the most white boxes. On the other hand, the members exhibiting the fewest universal attributes appear on the left side and have been given the most black boxes. The rating given to each of the boxes may be determined by averaging the responses given by each of the participants. Then, in view of the diagnoses, the group may be asked to gauge the likelihood of a successful change effort with the entity if the ratings remain unchanged.

For ease of administration, this exercise can be dramatically accelerated by focusing solely on the aggregated opinions of each individual's “top five and bottom five” in an organization. That is, rather than cast a vote on every member of a unit/group/organization, each individual is asked to vote only on their own “top five and bottom five,” and a profile (e.g., an “eye chart” 880) may be determined for individuals who appear in the top five and bottom five of more than one participant. In other words, individuals who are disproportionately mentioned as either “top five” or “bottom five” are more conspicuously displayed on the “eye charts.”

At this point, a majority of the participants appreciate the damaging effects of members that exhibit poor performance with respect to the universal attributes. They are asked to imagine their workplace without such individuals. While the goal of module 200 is not to identify and terminate members with poor performance with respect to the universal attributes, module 200 does encourage the participants to improve their performance with respect to the universal attributes and to expect others to improve also. In essence, the module 200 endeavors to make the participants somewhat intolerant of members that exhibits poor performance with respect to the universal attributes.

Returning to FIG. 5, at this point, in optional block 882, the participants may be asked to take an oath. The oath includes a promise to work toward exhibiting the universal attributes. A non-limiting example of the oath may include the following:
I pledge to live the Universal Attributes, every conversation, every time, with everybody to the very best of my ability, and to be open to feedback (positive and corrective) from any of my peers and colleagues . . . beginning today.

Having identified desirable behaviors, the method 860 now turns to identifying undesirable behaviors. Without being limited by theory, aspects of the invention may be considered as inspired by the philosophy of “The Tipping Point” by Malcolm Gladwell. In block 884, the lessons of “The Tipping Point” may be presented to the participants. Those lessons include how crime in New York City was dramatically reduced by an obsessive focus on two seemingly inconsequential misdemeanors: graffiti and fare-beating (i.e., jumping over the turnstiles to avoid paying a fare) in the subway system. According to the city's leaders, including then Mayor Rudolph Giuliani, Chief of Police William Bratton and NY City Transit Authority leader David Gunn, the singular focus in aggressively reducing the frequency of these misdemeanors was of the utmost importance in reducing the overall crime rate, including murders and assaults.

Block 886 applies this lesson by asking the participants to identify behaviors occurring in the organization that are analogous to graffiti and fare-jumping. By way of a non-limiting example, behaviors engaged in by physicians that are analogous to graffiti and fare-jumping (“undesirable behaviors”) may satisfy one or more of the following criteria:
1. the behavior is performed by physicians, but may also apply to others in the organization
2. the behavior occurs commonly (e.g., to the point of pervasiveness);
3. the behavior is tolerated;
4. the behavior is recognized by most if not all as wrong;
5. the behavior has a significant negative impact on others (e.g., patients, family members of patients, staff, and the like);
6. the behavior can be reversed (if the will exists to do so); and
7. the behavior is of a type that can be observed, measured, and monitored (and thus lends itself to evaluation).

Block 886 may include identifying universal group graffiti behaviors, universal personal graffiti behaviors, and the like. Division into small groups, “The Wisdom of Crowds,” and the like may be used to identify these universal graffiti behaviors. By way of a non-limiting use of the division into small groups method to identify universal group graffiti behaviors, in block 886, the participants may divide into small groups. Each group member may be asked to write down “N” types of conduct that represent “graffiti and fare-jumping” within the organization. The individual responses may be shared with the small group, which selects a single item that is the undesirable behavior that if eliminated would make the biggest impact. The small groups then share their biggest impact item with the rest of the participants. These items are then used to create a list of undesirable universal group graffiti behaviors. By way of non-limiting example, a group of physicians may identify the following list of universal group graffiti behaviors:
1. Physicians voicing negative opinions about patients to staff;
2. Disrespect for the rules;
3. Using e-mails inappropriately;
4. Talking down to others;
5. Saying no to consult requests;
6. Erecting barriers that isolate physicians from one another; and
7. Brow-beating, acting out, exhibiting a lack of collegiality.

Then, the participants may be asked to imagine the organization after the elimination of the universal group graffiti behaviors. Typically, the participants experience a moment of discovery (or an “ah-ha” moment) when they realize how much better the organization would be without these graffiti behaviors.

Next, the participants perform an exercise in which each participant is asked to create a list of their own personal graffiti behaviors. For example, each participant may write down a predetermined number of personal graffiti behaviors (e.g., 3) of which the participant is aware he/she does under stress. Such a list may begin with the statement “I'm not proud of it, but I have . . . ” The list is shared with the small group of which the participant is a member and used to create a list of personal graffiti for the small group. Then, the group creates a universal personal graffiti list using the lists prepared by the small groups. The list of universal personal graffiti behaviors may include any number of personal graffiti behaviors. By way of a non-limiting example, the list may include a single personal graffiti behavior. An exemplary list of universal personal graffiti behaviors may include one or more of the following behaviors:
1. Working not to work;
2. Learned helplessness (apathy);
3. Focusing on the negative;
4. Bashing others (individuals, departments);
5. Negative verbal discussions; and
6. Blame and negativity.

Then, the small group may be asked to take an oath or make a pledge to not engage in the universal personal graffiti behaviors and support each other in the elimination of these behaviors. This support may include pointing out universal personal graffiti behavior to each other when it occurs.

Then, the group may be asked questions, presented with challenges, and the like related to the lists of universal personal graffiti behaviors. By way of non-limiting example, these questions may be presented to the group using “The Wisdom of Crowds” method. For example, the participants may be asked, “Would the organization be a better place to work, receive services (e.g., medical care), practice, and the like if every member of the organization eliminated the universal personal graffiti behaviors?” Typically, at least a majority portion of the participants will respond “YES.” Then, the participants are asked, “Do you set the tone at the organization?” Again, typically, at least a majority portion of the participants will respond “YES.” At this point, each participant's responsibility for the present state of the organization and influence over the present state is becoming more clear to the participants.

Optionally, to press the participants further toward changing their own behavior, the participants may be asked, “Can you expect or ask others to stop their graffiti without first stopping your own personal graffiti?” In other words, the module 200 reiterates the participant's role in shaping the present state and at the same time introduces the concept of shaping the environment at the organization to facilitate desirable behaviors (e.g., exhibition of the universal attributes) and to hinder undesirable behaviors (e.g., exhibition of the graffiti behaviors). Shaping the environment is explored further in modules 400 and 500. Typically, at least a majority portion of the participants will respond “NO,” because to respond otherwise would be at least somewhat hypocritical.

Then, the participants are asked, “Is it worth the effort to begin changing my own behavior, no matter what anybody else does?” This question or an equivalent thereto is constructed to motivate the participants to begin eliminating the universal personal graffiti behaviors. This type of question avoids the perception that unless others change their behavior there is no point in any one participant taking steps to improve his/her own behavior. This type of thinking often results in stagnation in which no one is willing to take the first step (i.e., knock down first domino). By formulating the questions according to the present teachings, the participants are oriented toward instituting behavioral changes even through they may not receive any assurances anyone else will do the same.

The universal attributes represent individual behaviors that influence the present state of the organization toward the ideal state and away from the disaster state. In contrast, the graffiti behaviors represent individual behaviors that influence the present state of the organization toward the disaster state and away from the ideal state. Because the participants have control over their own individual behavior, at this point, they have obtained an awareness of their role in both the solution and the problem. In other words, the participants are obtaining an awareness of how their behavior helps the organization to achieve the ideal state or hinders the organization from achieving the ideal state. This awareness may also represent a moment of discovery or “ah-ha” moment for the participants.

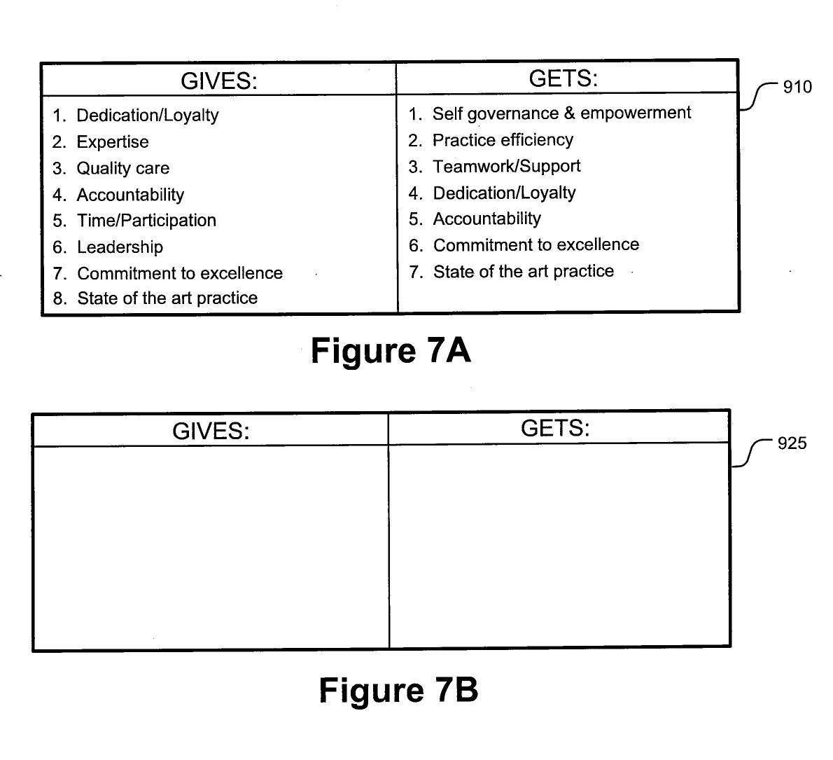

After the graffiti behaviors have been identified in block 886, the method 860 advances to block 888, in which the participants create a declaration 910 (see FIG. 7) between themselves and the organization or alternatively, between themselves and the other members of the organization. While the declaration 910 may be between an individual participant and the remainder of the organization, all of the participants may draft the declaration 910 together and agree to the same terms. Without being limited by theory, the declaration 910 may be based on a compact described in Jack Silversin and Mary Jane Kornacke, “Leading Physicians Through Change: How to Achieve and Sustain Results, Tampa: American College of Physician Executives, 2000, Chapter 3: Culture and Compact, pp. 45-60.

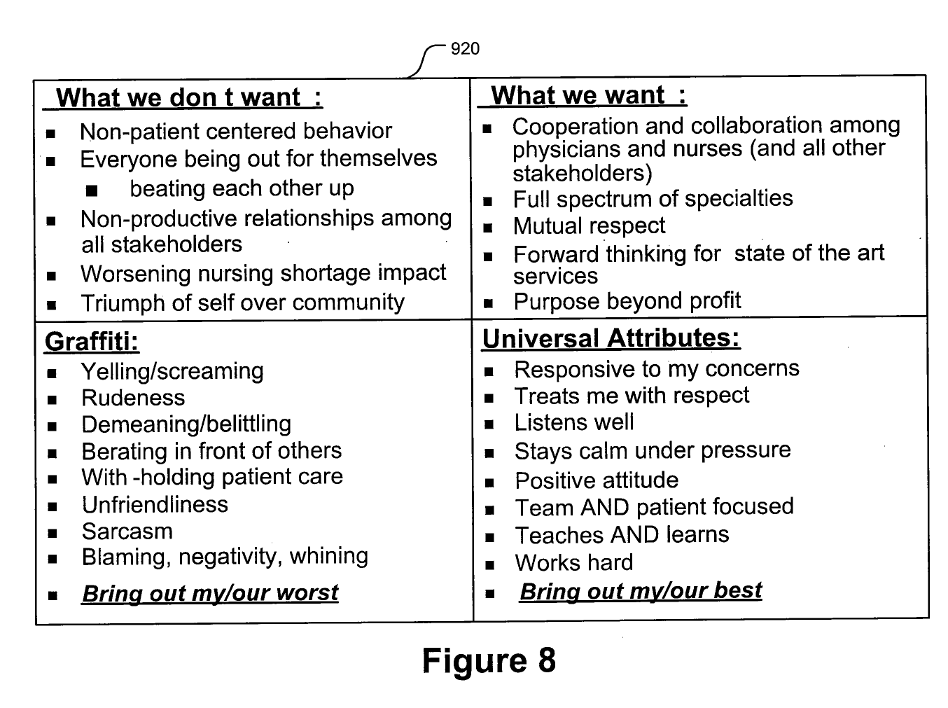

Block 888 may begin by asking the simple question, “what do the participants want?” The items that the participants want may be considered “gets” because these are the items the participants would like to get or receive. Then, block 888 may ask the participants, “what are you willing to give to get those items?” Generally speaking, the participants want to “get” and are willing to “give” (or exhibit) profitable values and profitable behaviors. Stated another way, the “get” list includes at least a portion of the description of the ideal state as well as the universal attributes and the “give” list includes at least a portion of the description of the disaster state as well as the graffiti behaviors. An example chart 920 depicting responses to these questions is shown in FIG. 8.

Example “gives” may include (1) putting patients at the center, (2) loyalty to the community, to the organization, and to each other, (3) time, involvement, patience, availability, and participation, (4) attention to relationships, which may include accountability, integrity, transparency, empathy, respect, listening better, recognizing contributions of physicians, staff and administration, and (5) support to succeed, which may include assisting physicians in need of assistance, helping with hospitalists, commitment to retention and recruitment, and viable joint ventures.

Example “gets” may include (1) loyalty to the community, to the organization, and to each other, (2) engaged physician partners, (3) collaborative effort to face challenges, (4) improved patient satisfaction, (5) physician pride, (6) loyalty, support, and respect, (7) good citizenship, (8) a world class facility/care, which may include dedicated staff, high quality healthcare, and easy recruitment of new members, and (9) a growing dynamic organization, which may attract more referrals and experience fewer members leaving the organization (“outmigration”).

Alternatively, by way of another non-limiting example, drafting the declaration 910 may begin by analyzing the mismatch between the desires/expectations of the physicians and the demands of business. A traditional “compact” or quid pro quo for a physician is a promise to treat patients and provide quality care in exchange for autonomy, protection, and entitlement. However, other concerns such as improve safety/quality, provide service, be patient-focused, improve access, improve efficiency, and the like often impose on the physician's autonomy, protection, and entitlement.

Then, the participants may engage in a dialog in which the expectations of the participants and/or organization are explicitly re-defined. The participants may be asked to answer the following questions:
1. What is a physician expected to provide?
2. What does a physician expect to receive in exchange?
3. How well does what the physician expects align with the reality imposed by other concerns?
   Then, the needs and expectations of the organization are explicitly defined. Fundamentally, block 888 may use the approach that when an existing compact crumbles without a conversation, anger and frustration will result.

Having discussed what the participants want (“gets”) and some of the things they are willing to forego (“gives”) to receive those “gets,” in block 888, the participants may explore in more detail what they are willing to give to get what they want. This analysis focuses on those things under the control of the participants and/or the organization.

In block 888, the participants may split into smaller groups. Referring to FIG. 7B, each member of a group completes a blank “give/get” grid 925. The presenter(s) instruct the participants that the items listed on the give/get grid 925 should aim to place the organization closer to the ideal state. Further, the “gives” and “gets” should focus largely on behavior. The members of a small group share their give/get grids with one another and consolidate the information contained therein to determine a top “Z” number of responses. The number “Z” of top responses may range from one to twenty. Then, the small groups may be merged together and their top “Z” number of responses consolidated across all of the small groups. The goal of the collective give/get grid (e.g., 1-3 items) is to obtain a list of items with which all of the participants “can live.”

Non-limiting examples of “gets” for a physician may include the following:
1. happy patients;
2. quality care;
3. quality of life;
4. quality staff (who are happy);
5. reasonable income;
6. a well run hospital;
7. recognition/reputation;
8. honesty;
9. support from the hospital (e.g., IT, equipment, facilities);
10. professional fulfillment/satisfaction;
11. a doctor's lounge for respite and a gathering place; and
12. respect by others.

Example “gives” for a physician may include the following:
1. putting the patient in the center;
2. expertise and quality of care;
3. time, effort, intellect, participation;
4. participation in a leadership role; partnership in cost containment;
5. honesty;
6. being part of the solution; customer service attitude;
7. openness to the evidence/data leading to behavioral change; engagement;
8. willingness to get out of their comfort zone; and
9. self-awareness of how we impact our environment.

The collective give/get grid is then used to create the declaration 910. In particular embodiments, the declaration 910 may simply be the collective give/get grid. The declaration need not be reduced to a single written document, like a standard legal purchase and sale agreement.

In the declaration 910, participants agree to give the organization what it needs to meet clear and real imperatives and in exchange, the participants get what is important to them, what supports them in meeting the organization's needs, and a promise that is sustainable (for the foreseeable future). The declaration 910 generally supports the following with respect to the members of the organization:
1. Belief that this is important work—essential to execute strategies successfully;
2. Clarity about what new norms mean for you personally—what behaviors might you need to change;
3. Conscious modeling of appropriate behaviors;
4. Willing to be held to account; willing to give colleagues feedback;
5. Explicit communication to new physicians regarding expected behaviors; and
6. Understanding how changes that are “hardwired” into the organization are intended to reinforce desired norms.

After the participants have drafted the declaration 910, in block 890, the presenter(s) obtain an indication of assent to or acceptance of the declaration 910. In other words, the participants are asked to ratify the declaration 910. The indication of acceptance may be in the form of a showing of raised hands, applause, taking of an oath to comply with the declaration, signing a copy of the consolidated give/get chart (e.g., the declaration 910), and the like. The indication of acceptance evidences the participants' willingness to improve their own individual behaviors based on their belief (obtained by completing the modules 100 and 200) that doing so will result in an improved present state (i.e., will move the present state toward the ideal state and away from the disaster state) within the organization. Preferably, at least a majority portion of the participants ratify the declaration 910.

In summary, during module 200, the participants may have participated in exercises related to identifying the universal attributes, ranking themselves and others with respect to the universal attributes, identifying graffiti at the organization, identifying their own graffiti, and creating the declaration 910. The deliverables produced by the second module 200 are the list of universal attributes, a list of universal group graffiti behaviors, a list of universal personal graffiti behaviors, and the declaration 910. The deliverables may also include eye charts (such as the “eye chart” 880 is shown in FIG. 6) for the participants, the organization, departments of the organization, individual members of the organization, and the like. The deliverables may also include the indication of acceptance of the declaration 910.

Returning to FIG. 1, optionally, in block 250, the participants may be assigned homework to be completed before the system 10 advances to the third module 300. As is apparent to those of ordinary skill, one or more moments of discovery (e.g., an “ah-ha” moment) may occur during the second module 200. Further, the participants have made at least one promise. The promise(s) made may include an oath to exhibit the universal attributes, support other participants in their efforts to exhibit the universal attributes, and a promise to comply with the declaration. Therefore, the homework assigned may be oriented toward monitoring progress with respect to fulfillment of those promises. For example, the participants could be asked to keep a journal, tally, and the like of their own exhibition of behaviors categorized as universal attributes or graffiti. The participants could also be asked to list or tally behaviors by others falling into the universal attribute and graffiti categories. By way of further example, the participants could also be asked to list or describe their efforts to help others exhibit universal attributes.

Depending on the particular implementation of the second module 200, the second day may end at this point. This allows the participants to reflect on the materials presented before beginning the third module 300. This may also allow the participants to return to the organization and complete their homework assignments. Further, the participants can report back to the presenter(s) regarding the effectiveness of the lessons learned during the first module 100 and/or second module 200.

### Module 300

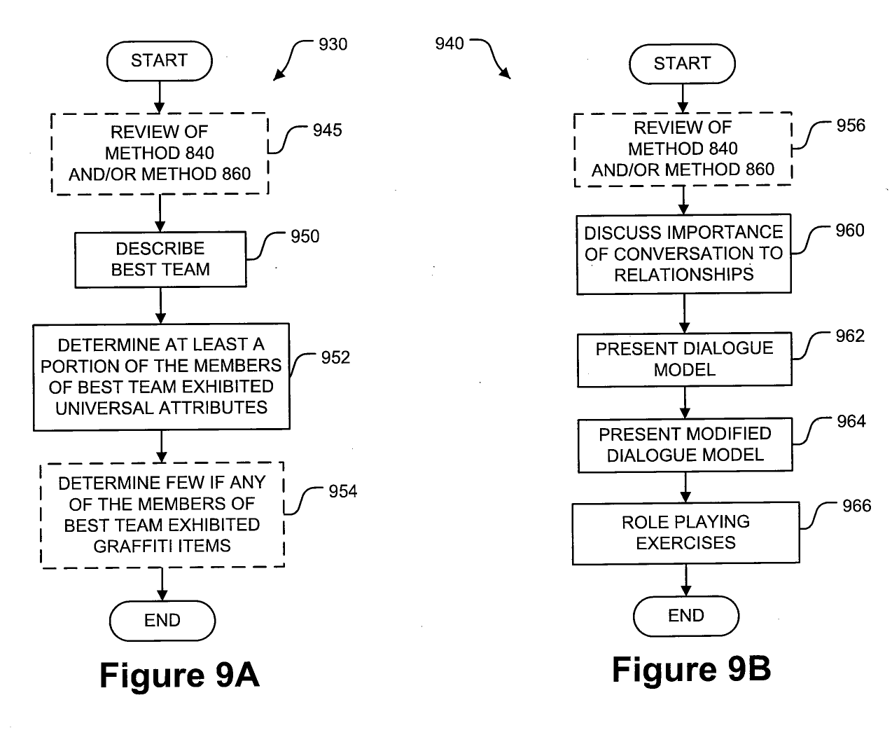

As mentioned above, aspects of the module 300 may be viewed as corresponding to the profitable teamwork tier 730 (see FIG. 2). The third module 300 is structured around discovering and promoting profitable teams through promoting conversational skills. A profitable team may be defined as a team having members operating on a common ground. Such members have clear roles and responsibilities with honest, transparent relationships that create “win-win”results and build trust amongst the team members. The module 300 may perform at least one of two methods 930 and 940 depicted in FIGS. 9A and 9B, respectively.

While the third module 300 corresponds to the profitable teamwork tier 730 (see FIG. 2), the third module may also be described as a communication module because it facilitates teamwork by improving the communication skills of the participants. By way of a non-limiting example, the module 300 could be structured to reduce or eliminate the fear of certain conversations (e.g., conversations that make the participants uncomfortable, are emotional or confrontational in nature, and the like).

Referring to FIG. 9A, the method 930 may begin in block 945 with an optional review of the method 840 and/or the method 860. Then, in block 950, each participant is asked to identify the best team of which he/she has ever been a member. Then, each of the participants share his/her team experiences with the other participants. During the sharing portion, the members are asked to listen for common features within these experiences. In particular, the members are asked to consider the following:
1. What was good about your best team experience;
2. What made it successful;
3. What made it such a great experience; and
4. Think of key words that epitomize this experience.

Then, the instructor may provide instruction with respect to the five dysfunctions of a team or why teams typically fail to achieve their functional purpose. Without being limited by theory, Lencioni's five dysfunctions of a team (i.e., five reasons teams fail) may be presented. Those reasons include (1) lack of trust between the team members, (2) fear of conflict, (3) lack of commitment, (4) avoidance of accountability (5) inattention to results. Patrick Lencioni, “The Five Dysfunctions of a Team: A Leadership Fable,” San Francisco: Jossey-Bass (2002).

At this point, the participants have constructed a list of the features of a desirable team and have been provided some instruction with respect to why some teams are unsuccessful. The method 930 then advances to block 952. In this block, the participants compare the list of the features of a desirable team with the universal attributes and likely conclude that at least a portion, and likely a majority portion, of the members of the desirable team exhibited many, if not all, of the universal attributes. This leads the participants to conclude profitable teams are composed at least in part of team members exhibiting the universal attributes. Further, a team having members that exhibit the universal attributes is likely to be a desirable team and a team that is able to achieve its functional purpose.

Optionally, in block 954, the participants may compare the list of the features of a desirable team with the universal group and personal graffiti behaviors. Such a comparison will likely result in the conclusion that few if any of the members of the desirable team exhibited the any of the graffiti behaviors. This leads the participants to conclude profitable teams are not composed even in part of team members exhibiting the graffiti behaviors. Further, a team having members that exhibit the graffiti behaviors is unlikely to be a desirable team or a team that is able to achieve its functional purpose.

Referring to FIG. 9B, in the method 940, the participants learn the importance of conversation to relationships and forming profitable teams. Emphasis in method 940 may be placed on the observation that communication is not the same as conversation. The method 940 may begin in block 956 with an optional review of the method 840 and/or the method 860. Next, a quotation from a well-respected source may be presented. For example, the following quotation from Sir William Osler (1849-1819), “the father of internal medicine,” “listen to the patient: he is telling you the diagnosis” may be presented. Then, statistics relating poor communication and malpractice may be discussed. For example, a Google search reveals a large number of hits for the search key words “physician,” “poor communication,” and “malpractice.” The number of hits increases significantly when the search string is changed to “physicians,” not listening,” and “malpractice.”

In block 960, the participants may be asked to recall an actual conversation with he/she had with another person, which may include another participant, although this is not a requirement. The recall may include a discussion of the conversation or merely thinking about the conversation. The recall may include who started the conversation, what was said, and how the conversation ended. The statements made by each of the participants may be separated according to which participant made the statement. This sample conversation may be used to illustrate the difference between a casual conversation and a much more difficult or challenging conversation. This conversation may also be used to illustrate how it forms the basis of interpersonal relationships.

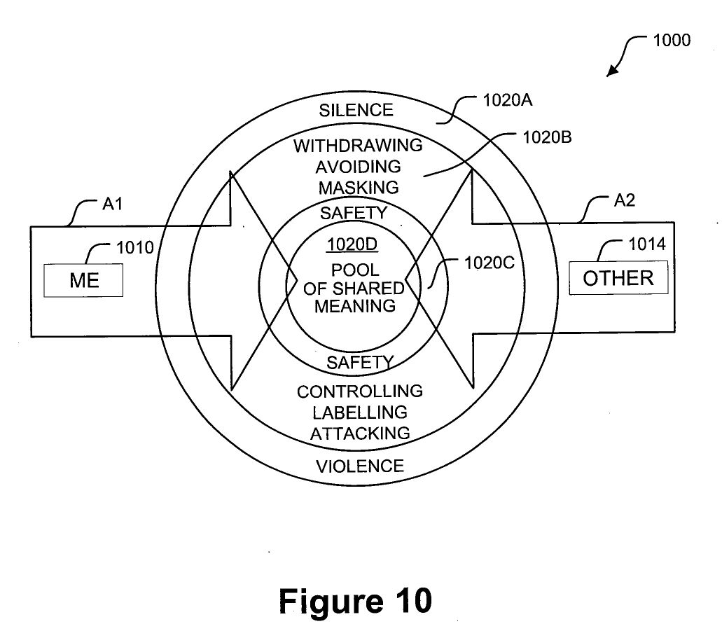

At this point, “the dialogue model” created by Patterson, K., et al., and published in “Crucial Conversations” may be presented. In block 962, the presenter(s) may present an illustration of the dialogue model 1000 such as that provided in FIG. 10. The dialogue model 1000 models conversation between a participant (“ME”) 1010 and another member or members of the organization (“OTHER”) 1014. Arrows A1 and A2 illustrate the “ME” 1010 and “OTHER” 1014, respectively, traversing the various layers 1020 A-D of conversation as their ability to communicate with one another improves. The outermost layer 1020A is silence and/or violence. Silence is clearly the absence of communication and represents withdrawal from communication (or exhibition of the “flight” instinct). Violence is another behavior completely antithetical to communication and represents confrontation when presented with an attempt to communicate (or exhibition of the “fight” instinct).

Moving inwardly, the next layer 1020B is withdrawing, avoiding, masking, controlling, labeling, and attacking. While some communication may occur in layer 1020B, the level of communication is considered poor. Moving inwardly the next layer 1020C is safety. Safety represents safe communication (e.g., small talk, non-challenging conversations) in which very little information of significant is typically conveyed. The innermost layer 1020D represents open dialogue and a pool of shared meaning. In this layer, a maximum amount of communication and exchange of information may occur between a pair of conversants.

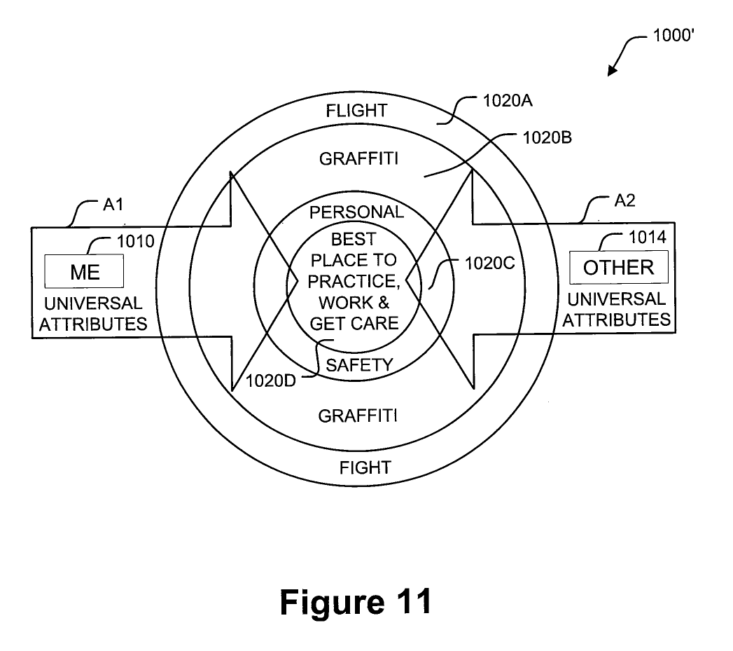

Returning to FIG. 9B, in block 964, the presenter(s) may present a modified version of the dialogue model 1000′, illustrated in FIG. 11. This modified version is labeled to incorporate the ideal state, disaster state, graffiti behaviors, and universal attributes. The outermost layer 1020A (formerly silence and/or violence) corresponds to the disaster state. The layer 1020A may be labeled “flight” and “fight.” The next layer inward of the outermost layer 1020A (formerly withdrawing, avoiding, masking, controlling, labeling, and attacking) is the behavior listed in the graffiti behaviors. The safety layer 1020C is labeled “personal” and “safety.” The innermost layer 1020D corresponds to the ideal state. The layer 1020D may be labeled in a manner that reflects the ideal state. For example, the layer 1020D may be labeled “best place to practice, work & get care.” The means by which the ability of the conversants improves to traverse the layers is the exhibition of the universal attributes.

Referring to FIG. 9B, at this point, the module 300 shifts its focus to training the participants how to have difficult or crucial conversations with others. Crucial conversations are necessary conversations that are difficult because one or more of the conversants is uncomfortable, emotional, confrontational, and the like. Successful crucial conversations may be referred to as “compassionate conversations” or “safe conversations.” In other words, instead of focusing on basic communication skills, the module 300 explicitly addresses how to handle the most difficult types of conversations with a goal of reducing or eliminating fear of such conversations. To achieve this, block 966 may employ the “see one, do one, teach one” methodology discussed above.

For example, in the “see one” portion, the presenter(s) may present an example of a successful crucial conversation to the participants. The example crucial conversation may be taken from one or more movie clips. Suitable movie clips may include the opening scene from the movie “Miracle,” scene 16 from the movie “Master and Commander,” and the like. Another example of a suitable movie clip includes scenes 6, 7, and 8 from Gettysburg in which a group of soldiers are told their enlistment is one year longer than they understood it to be. The soldiers decide to resist fighting and following orders. Their commander is told to force them to fight by any means necessary including executing one or more of them. After the clip, the group is asked to analyze “Moments of Truth” (i.e., facts with which the parties must contend). Examples of such moments of truth may include the circumstances surrounding the following statements:
1. “You want to shoot 'em, go right ahead.”
2. “Colonel, we've got grievances.”
3. “How many (engagements) have you been in?”
4. “The courier, sir.”
5. “You can't shoot them. You'll never go back to Maine if you do.”

After viewing the movie clip(s), the participants are asked to discuss how the crucial conversation at each moment of truth was conducted, whether it was successful, what may have occurred if different behavior was exhibited, and the like. For each “moment of truth,” the participants may be asked to provide example responses that would be in accordance with the universal attributes and responses that would be in accordance with the graffiti behaviors. Table A below provides exemplary responses to each of the moments of truth in accordance with the graffiti behaviors (leftmost column) and the universal attributes (rightmost column).

TABLE A

| “Obnoxious” | Stimulus or | | “Healthy” response |
|---|---|---|---|
| response (“Graffiti”) | “Moment of Truth” | | (“Universal Attributes”) |
| “I just have to shoot | 1. | “you want to | “That won't be |
| ONE of them.” | | shoot them, go | necessary.” |
| | | right ahead” | |
| “BANG” | 2. | “Colonel, we've | “Okay, I'd like to hear |
| “don't we all” | | got grievances” | them.” |
| “get in line” | | | “Go eat first, then I'll |
| | | | come listen to you.” |
| “None of your | 3. | “how many | “Probably not as many |
| business” | | engagements have | as you.” |
| “Hey, I'm the one | | you been in?” | “We sure could use |
| asking the | | | men with a lot of |
| questions” | | | experience.” |
| “We're DONE.” | 4. | “the courier, sir” | “Please tell the courier to |
| | | | wait until I'm finished |
| | | | here.” |
| “I'm not going to . . . | 5. | “you can't shoot | “I'm not going to.” |
| YOU are.” | | them, you'll | |
| | | never go back to | |
| | | Maine if you do” | |

Optionally, moments of truth of a more targeted relevant nature may be discussed. Such moments of truth may include events related to the functional purpose of the organization. For example, if the participants are a group of physicians, exemplary moments of truth may include a loss of position of power or status, a complaint from the frontline (e.g., subordinates, other staff members, patients, and the like), a challenge to expertise or authority, others insulting the organization, loss of an advantage (e.g., a bargaining chip), and the like. For each moment of truth, the participants may provide example responses that would be in accordance with the universal attributes and responses that would be in accordance with the graffiti behaviors. The “universal attribute” responses are considered healthy responses and the “graffiti” responses are considered obnoxious responses.

The participants may also begin to understand how behavior during a crucial conversation translates into effective leadership. Because of the nature of their position, physicians are often seen by themselves, the organization, and other medical staff as leaders, whether they exhibit leadership skills or not. The group may construct a list of universal leadership behaviors using any method described above. Alternatively, a list may be presented to the group. By way of a non-limiting example, the following list of leadership behaviors may be used:
1. Role models effective leadership for the medical staff;
2. Is an instrument of propagating respect and trust throughout the hospital;
3. Displays honesty and transparency and without self-interest;
4. Participates in initiating action (is a “champion”);
5. Balances the viewpoint of the medical community with that of administration;
6. Is an open-minded listener; and
7. Is an advocate for patients.
   The above list represents exemplary leadership behaviors physicians and others, including the organization, would like to see exhibited by physicians. Ideally, every physician within a medical organization would exhibit these behaviors.

The group may then participate in an exercise designed to illustrate the connection between communication and leadership. Because a sailing ship has a clear leader, its captain, a movie clip in which a ship's captain is faced with a leadership challenge may be useful in further demonstrating the connection between effective communication and leadership. An example of such a clip includes a scene from Master and Commander in which the ship is under attack from a second larger ship. The deck is in chaos and little time exists to inspire or motivate the crew. However, in the scene, the ship's captain is able to comprehensively assess the situation, relay clear, coherent orders to a number of subordinates, simultaneously, chastise and correct a younger crew member to rise to the occasion, demonstrate cool courage under fire, and inspire the confidence of all others, despite the bleakness of the situation.

After viewing and discussing the movie clip, the participants should arrive at a list of characteristics of an effective leader conducting a crucial conversation:
1. Clear and unambiguous directions;
2. Displaying cool courage under fire;
3. Acts as a role model; and
4. Inspires confidence.

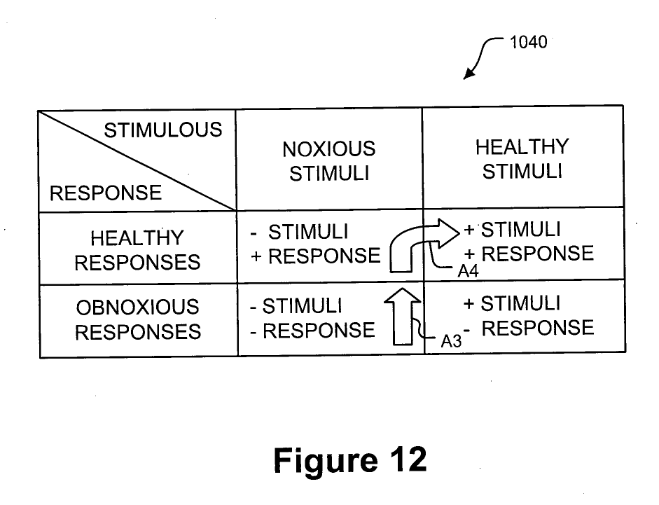

To explore how to display effective communication skills under stress, without being limited by theory, a table 1040, such as that depicted in FIG. 12, based on “Man's Search for Meaning” by Viktor Frankl, MD, PhD may be presented. Viktor Frankl, “Man's Search for Meaning,” Boston: Beacon Press (2006). The essence of Dr. Frankl's teachings is “between stimulus and response there is a space. In that space is our power to choose our response. In our response lies our growth and our freedom.”

Referring to FIG. 12, the table 1040 depicts stimulus and possible responses (e.g., healthy response, obnoxious response, and the like) thereto. The purpose of the table 1040 is to illustrate that a healthy response (e.g., a universal attribute response) to all stimulus, even noxious stimulus, is not only desirable but achievable if conscious effort is undertaken. The arrows A3 and A4 illustrate a path to improvement if each participant modifies his/her response to noxious stimuli. In essence, as one's own responses improve, the responses of others improve. As the responses of others improve, the stimuli changes from noxious to healthy.

During the “do one” portion, the participants are asked to divide into small groups (e.g., 3-4 participants) and conduct practice dialogue sessions (e.g., role playing) in which they practice having compassionate conversations. By way of a non-limiting example, each participant may be asked to write down a compassionate conversation he/she needs to have with someone and the participant's goal for the conversation. Optionally, each participant may be asked to create a list of conversations he/she needs to have with one or more other people having various levels of difficulty.

By way of a non-limiting example, using “The Wisdom of Crowds” method, the participants may be asked as a group, to shout an example of a compassionate conversation that is “easy,” “medium,” and “difficult.” The group may evaluate the example conversations and re-categorize the examples if necessary. A non-limiting example of an easy conversation may include asking a coworker to perform a routine job junction, e.g., asking a coworker to handle the admission of a new patient. A non-limiting example of a medium conversation may include asking a coworker why he/she did not perform a particular routine job function, e.g., asking a coworker why he/she did not take a patient's vital signs. A non-limiting example of a difficult conversation may include discussing inappropriate behavior exhibited by a coworker with that coworker, e.g., discussing a complaint received about the coworker's inappropriate behavior with the coworker.

These examples may be written down so that the participants can view and refer to them. While three levels of difficulty have been described, it is apparent to those of ordinary skill that greater or fewer levels may be used and the present teachings are not restricted to a particular number of levels.

The lists of conversations at various levels of difficulty may be prepared for use as a homework assignment (for block 350 of FIG. 1). Each participant may prepare a list of conversations at various levels of difficulty that he/she will be having after the participant returns to the organization. The role-playing may then serve as practice in anticipation of these conversations.

Then, the participants may role-play at least a portion of the conversations on the list at each level of difficulty. The role-playing may involve four roles: a sender; a receiver; a first observer who observes the sender; and a second observer who observes the receiver. One of the participants (e.g., the participant playing the role of sender) chooses one of the compassionate conversations on his/her list and conducts a brief (e.g., about five minute) conversation with the receiver as the observers observe the conversation. After the completion of the conversation, the participants may critique the conversation. By way of non-limiting example, the observers may describe what they observed (e.g. exhibition of graffiti behaviors, universal attributes, and the like). The sender and receiver may describe how the conversation felt, their impressions, whether the goal of the conversation was achieved, and the like. Optionally, the participants may switch roles until each participant has played all four roles.

Alternatively, for each conversation, the participants may role-play the conversation using the universal attributes and separately, may role-play the conversation using the graffiti behaviors. Such role-playing demonstrates the differences between these conversations and helps the participants recognize compassion conversations (i.e., conversations on layer 1020D of the dialogue models 1000 AND 1000′, see FIGS. 10 and 11) and dysfunctional conversations (i.e., conversations on layers 1020A and 1020B of the dialogue model).

Finally, the “teach one” occurs as the participants role-play, evaluate each other's performances, critique the conversation, and the like. The “teach one” may also occur back at the organization as a participant's communication skills improve to a level where he/she is seen as a leader or instructor capable of teaching others to improve their communication skills.

In some respects, the participants may find the module 300 to be more difficult than the modules 100 and 200, which focus on obtaining insight (e.g., an “ah-ha’ moment). The module 300 focuses on learning skills and abandoning bad habits. Further, the module 300 teaches techniques for having crucial conversations and not merely communicating. Therefore, it may be necessary to repeat module 300 several times before advancing to the module 400. As is apparent to those of ordinary skill, if adequate time has passed between successive repetitions of the module 300, it may be beneficial to repeat module 100, module 200, or portions thereof. Alternatively, a review of a portion of the materials presented, the responses provided, and the like during those modules may be sufficient.

In summary, the deliverables of the module 300 may include a list of attributes of the best teams on which each participant has ever participated, a list of features of a desirable team, and the identification of one or more conversations, which may optionally be categorized according to level of difficulty. The participants may participate in exercises including describing their best team experiences and practice dialogue sessions. After completing module 300, at least a portion of the participants should understand the need to forego exhibiting personal graffiti, and the need to exhibit the universal attributes with respect to compassionate (crucial) conversations.

Returning to FIG. 1, optionally, in block 350, the participants may be given homework to be completed before the system 10 advances to the fourth module 400. The homework may include having the conversations listed and practiced during the practice dialogue sessions.

Depending on the particular implementation of the module 300, the third day may end at this point. This allows the participants to reflect on the materials presented before beginning the fourth module 400. This may also allow the participants to return to the organization and complete their homework assignments. Further, the participants can report back to the presenter(s) regarding the effectiveness of the lessons learned during the first module 100, second module 200, and/or third module 300.

### Modules 400 and 500

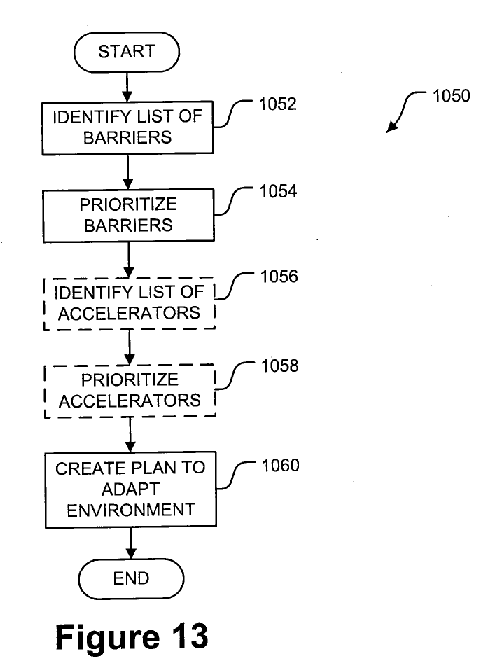

The modules 400 and 500 may include well-known process and system improvement methods and techniques. While these methods and techniques are well known, they are often not as successful as they could be. It is well known in the field of industrial engineering, which focuses on process improvement, that employees can sabotage any time or cost saving measure, rendering it ineffective. Consequently, even if most sophisticated methods are employed, without the cooperation and team work of the members of an organization, the efficacy of such efforts are limited. Therefore, a method 1050 depicted in FIG. 13 is performed by both the modules 400 and 500 before or in conjunction with other process and system improvement methods and techniques.

The method 1050 is directed toward making a correct, unifying diagnosis before beginning treatment (e.g., instituting traditional process and system improvement techniques). Referring to FIG. 13, the method 1050 begins in block 1052. In block 1052, the participants prepare a list of barriers. The list may be prepared using the division into small groups method, wisdom of crowds method, and the like. By way of a non-limiting example, the participants may each be asked to write down a predetermined number of items (e.g., 3) that “drive him/her crazy,” a predetermined number of items that keep him/her from exhibiting the universal attributes, a predetermined number of items that cause him/her to exhibit the universal personal graffiti behaviors, a predetermined number of items that prevent the organization (or a portion thereof) from reaching the ideal state, and the like. The lists prepared by the participants may be shared with members of a small group and the small group may use those responses to create a consolidated list for the small group. Optionally, the entire group may then review the small group lists and create a consensus list of barriers for the entire group. An exemplary list of barriers may include the following items:
1. Inability to find the information daily;
2. Lack of direct clinician to clinician communication;
3. Over-utilization of consults;
4. Excessive use of intermediaries;
5. Disconnect between physicians and administration (getting heard); and
6. Protocol barriers and “over-regulation” (over-zealous adoption).

Optionally, one or more of the following criteria may be used to select barriers:
1. Positive “downstream” impact
2. Under the participant's control
3. Large “bang for the buck” (80/20 rule)
4. Broad application across specialties
5. Broad application across disciplines
6. Broad application across departments
7. Broad application across sites
8. Can provide “concrete and measurable” results
9. Could have a “60-90 day turnaround” (rapid cycle change)

Next, in block 1054, each small group prioritizes the barriers on the small group list or alternatively on the consensus list for the entire group, if one was created. A barrier having a high priority is a barrier that if removed would result in the greatest improvement in the organization. Improvement is measured by the potential of the removal of the barrier to facilitate the exhibition of the universal attributes and to reduce the exhibition of the graffiti behaviors.

By way of a non-limiting example, the presenter(s) may present or review a list of initiatives the organization would like to accomplish. The participants may be asked to determine which single barrier, if removed, would enable the organization and/or the participants to achieve success in the greatest number of initiatives. Optionally, the participants may be asked to count the number of initiatives that are likely to achieve success with the removal of this single barrier.

In optional block 1056, the participants prepare a list of accelerators. The list may be prepared using the division into small groups method, wisdom of crowds method, and the like. By way of a non-limiting example, the participants may each be asked to write down a predetermined number of items (e.g., 3) that actually “make his/her job easier,” a predetermined number of items that would “make his/her job easier” if implemented, a predetermined number of items that facilitate his/her exhibition of the universal attributes, a predetermined number of items that discourage him/her from exhibiting the universal personal graffiti behaviors, a predetermined number of items that encourage the organization (or a portion thereof) toward reaching the ideal state, and the like. The lists prepared by the participants may be shared with members of a small group and the small group may use those responses to create a consolidated list for the small group. Optionally, the entire group may then review the small group lists and create a consensus list of accelerators for the entire group. An exemplary list of accelerators may include the following items:
1. Promoting of physician to physician communication;
2. Clarification of who's taking care of whom;
3. Obtaining agreement regarding protocols;
4. Increased use of IT; and
5. Providing rounding assistance for physicians.
   Optionally, one or more of the criteria listed above for use in selecting barriers may be used to select accelerators.

Next, in optional block 1058, each small group prioritizes the accelerators on the small group list or alternatively on the consensus list for the entire group, if one was created. An accelerator having a high priority is an accelerator that when present results in the greatest improvement in the organization. Improvement is measured by the potential of the accelerator to facilitate the exhibition of the universal attributes and to reduce the exhibition of the graffiti behaviors.

By way of a non-limiting example, the participants may be asked to determine which single accelerator, if present, would enable the organization and/or the participants to achieve success in the greatest number of initiatives. Optionally, the participants may be asked to count the number of initiatives that are likely to achieve success if this single accelerator is present.

While blocks 1056 and 1058 have been described as optional, it is apparent to those of ordinary skill in the art that in alternate embodiments, the method 1050 could include non-optional blocks 1056 and 1058 and optional blocks 1052 and 1054 could be optional without departing from the present teachings.

Finally, in block 1060, the participants develop a plan to adapt the environment within the organization to remove the highest priority barrier(s) and optionally, to ensure the presence of the highest priority accelerator(s). In this manner, the method 1050 may be viewed as directly opposite a “picking low hanging fruit” approach, which corrects easily correctable problems that seldom have significant affect on significant problems. To the contrary, the method 1050 identifies for action the top barriers and optionally, the top accelerators. The plan may be designed for a predetermined period of time. For example, the plan may be designed for a 60-90 day implementation. Further, the plan may include phases, which implement at predetermined intervals during the duration of the plan.

Optionally, the plan may be constructed one barrier at a time. For example, the participants could be asked (using any method discussed above) to select a barrier, provide a corresponding description of the organization without the barrier (e.g., the ideal state), list the root causes why the barrier exists, and prepare a plan how to reduce or eliminate the barrier bringing the present state closer to the ideal state.

As mentioned above, aspects of the module 400 may be viewed as corresponding to the processes tier 740. Profitable processes are defined as improved processes created by engaged teams to improve quality, safety, service, and/or efficiency. Profitable processes are a common approach applied by appropriate members of the organization. In other words, the fourth module 400 instills clarity of method.

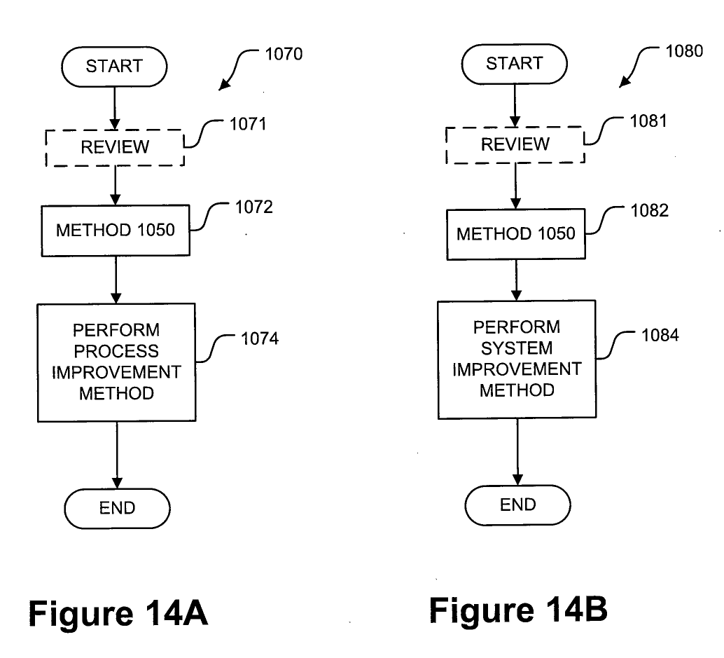

Referring to FIG. 14A, then, the module 400 performs a method 1070. In optional block 1071, the method 1070 may begin with a presentation of a review one or more of the modules 100, 200, and 300. As mentioned above, in block 1072, the method 1050 described above and depicted in FIG. 13, is performed. Then, in block 1074, any suitable process improvement method known in the art may be performed.

Returning to FIG. 1, in block 450, the participants may be given homework to be completed before the system 10 advances to the fifth module 500. The homework may include implementing the plan to eliminate the top barriers and the plan implementing the top accelerators.

Depending on the particular implementation of the module 400, the fourth day may end at this point. This allows the participants to reflect on the materials presented before beginning the fifth module 500. This may also allow the participants to return to the organization and complete their homework assignments. Further, the participants can report back to the presenter(s) regarding the effectiveness of the lessons learned during the first module 100, second module 200, and/or third module 300.

Turning now to module 500, as mentioned above, aspects of module 500 may be viewed as corresponding to the systems tier 750. Profitable systems are defined as systems that employ all the lessons of the modules 100, 200, 300, and 400 in a robust, disciplined, universal, and highly leveraged way. Profitable systems are systems in which appropriate members of the organization have common priorities. The fifth module 500 instills clarity of coordination.

Aspects of the module 500 may include expanding the teachings of the modules 100-400 to more members of the organization. For example, more departments and leaders within a single organization may attend the module 100. Further, the lessons of one or more organizations may be shared with additional organizations to facilitate improvement across those organizations.

Referring to FIG. 14B, the module 500 performs a method 1080. In optional block 1081, the method 1080 may begin with a presentation of a review of one or more of the modules 100, 200, 300, and 400. In block 1082 the method 1050 described above and depicted in FIG. 13, is performed. Then, in block 1084, any suitable system improvement method known in the art may be performed.

The module 500 may end with a presentation of a mission statement that summarizes the lessons learned and orients the participants. An exemplary mission statement may include the following items:
1. to accentuate the positive and eliminate the negative;
2. to transform healthcare by restoring compassion to the medical profession and harnessing the power of the healer's presence from bedside to boardroom; and
3. to lead through the example I set by my own attitudes, behaviors and conversations.

However, as explained above, the contents of the modules may be modified depending upon the needs of the organization. Further, the sequence of the modules and the order in which the content of the modules is presented may be varied. For example, it may be beneficial to introduce the mission statement earlier (e.g., in the module 100), to refer to or present the mission statement in other modules after its introduction, and the like.

The homework in block 550 may be substantially similar to that of block 450. Depending on the particular implementation of the module 500, the fifth day may end at this point.

As mentioned above, after the completion of the module 500, the modules 100-500 or portions thereof may be repeated. Further, in block 600, the presenter(s) may monitor the organization to evaluate whether any of the modules (or portions thereof) should be repeated. Further, the participants can report back to the presenter(s) regarding the effectiveness of the lessons learned during the modules 100-500.

### ALTERNATE EMBODIMENT

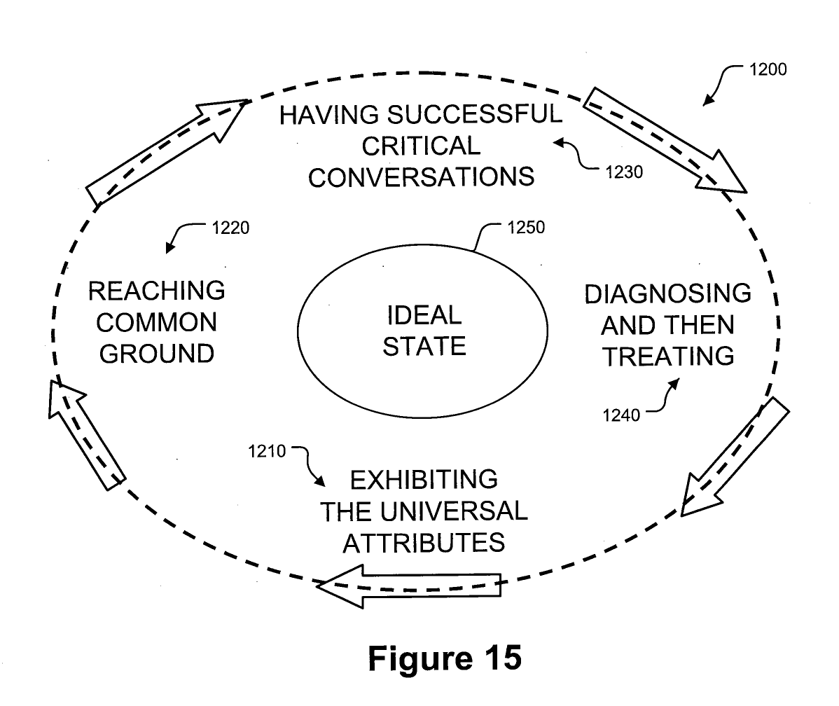

Referring to FIG. 15, an alternate embodiment of the system 10′ may be based on a cycle 1200 referred to as a TRUST Cycle. This embodiment focuses on building trust between the members of an organization because the inventors have determined mistrust is the root cause of many if not all of the problems in healthcare and trust is the only enduring, comprehensive solution to those problems.

Most healthcare professionals (especially doctors and nurses, but also including therapists, social workers, pharmacists, other staff and administrators) choose healthcare as a career to help people (e.g., help people get better, save lives, and the like). However, to help those in healthcare save more lives, healthcare professionals need to change their way of thinking, response to the environment, attitude, behavior, and communication (conversation) skills.

Healthcare is an amalgamation of smaller cottage industries and is therefore naturally fragmented, complicated, disjointed, and difficult to manage. Healthcare is arguably the most challenging industry in America today and is certainly the most expensive and refractory to any solution to date. For example, healthcare professional deconstruct this complexity to a vast array of tribes and sub-tribes, each healthcare professional belonging to a tribe. In this environment, healthcare professionals battle over what they perceive as a scarcity of resources, demonizing the opposition (e.g., members of other tribes) that does not agree with a particular resource allocation or disagrees with respect to other issues.

Healthcare suffers from poor performance across the board because healthcare professionals mistrust one another. This mistrust is rooted in tribal heritage, the triumph of “uniqueness” over “common ground” leading to warring tribes that demonize one another, further eroding any hope of teamwork. In other words, teamwork between the tribes (and in some cases within the tribes) suffers because at the very root of the problem, healthcare professionals do not trust one another. Instead of teamwork, many healthcare professionals resort to extraordinary heroic individual efforts. All of the aforementioned problems lead to a pervasive sense of despair and ennui across the healthcare industry. Therefore, if trust is restored, most if not all of the other problems in healthcare may be resolved.

At the beginning of the system 10′, the presenter(s) may present a “root cause” analysis to the participants explaining why mistrust is the root cause of many if not all of the difficulties in healthcare. For example, the analysis may begin by stating healthcare is the most difficult industry in America today. Then, a reason why healthcare is the most difficult industry in America today is presented: healthcare is divided into a massive array of tribes and sub-tribes. A reason why healthcare is divided into tribes and sub-tribes is presented: healthcare professionals lack “common ground.” Then, a reason why healthcare professionals lack “common ground” is presented: healthcare professionals would rather unite against a “common enemy” than for a “common good” (e.g. the health of the patient). Then, a reason for this is presented: “tribal warfare” leads healthcare professionals to demonize the opposition. A reason for demonizing the opposition is presented: healthcare professionals rely on heroic efforts at the expense of teamwork. A reason why healthcare professionals rely on heroic efforts is presented: a belief that if one wants something done right, he/she must do it himself/herself. Finally, a reason for this belief is presented: healthcare professionals do not trust one another.

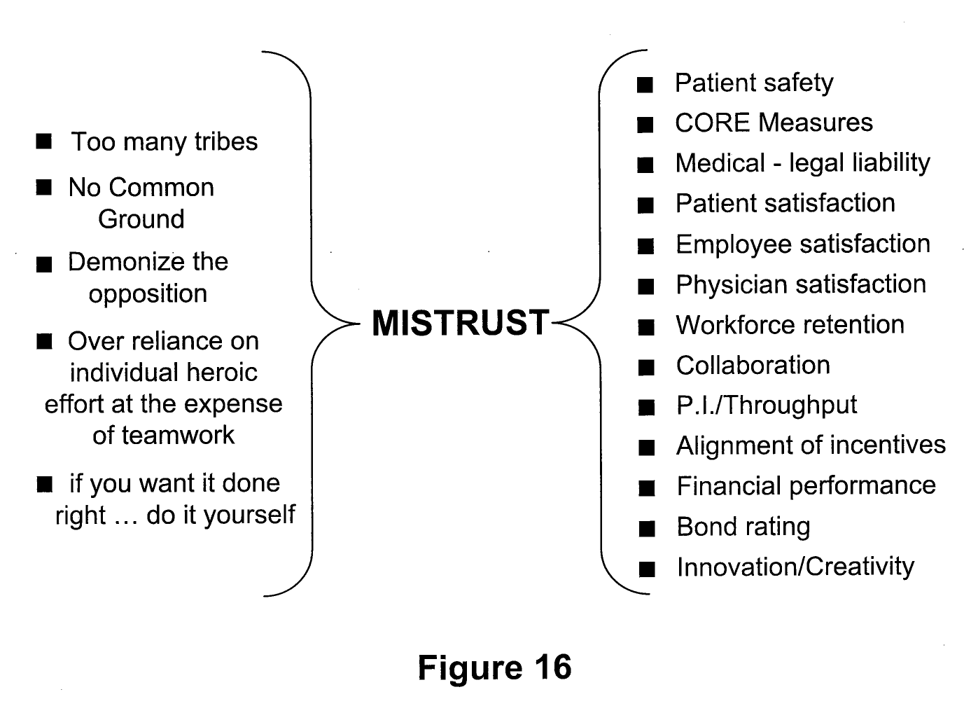

It may be beneficial to present a visual depiction of the reasons provided in the above “root cause” analysis to the participants. Referring to FIG. 16, the reasons provided in the “root cause” analysis appear along the left hand side of the figure. Along the right hand side of the figure, a list of desired results (e.g., patient, employee, and physician satisfaction) for the organization are provided. In the center of the figure, between the reasons and the desired results, the word “MISTRUST” is provided to illustrate that mistrust is the root cause and therefore a root barrier to obtaining the desired results.

The system 10′ teaches the participants four lessons. First, the system 10′ teaches the participants about the universal attributes and the importance of exhibiting the universal attributes. Second, the system 10′ teaches the participants about establishing common ground. Third, the system 10′ teaches the participants how to have successful crucial conversations. Finally, the system 10′ teaches the participants how to a diagnose root cause of a problem before trying to solve the problem. Because each of the lessons feeds into the next, the first lesson may be considered most important or a root cause of improvement or change.

As is apparent to those of ordinary skill in the art, the system 10′ is not limited to the exemplary order of the lessons described above. For example, in some embodiments, the order of the first lesson and second lesson may be modified so that the second lesson is taught before the first lesson. Further, in some embodiments, the order of the third lesson and fourth lesson may be modified so that the fourth lesson is taught before the third lesson.

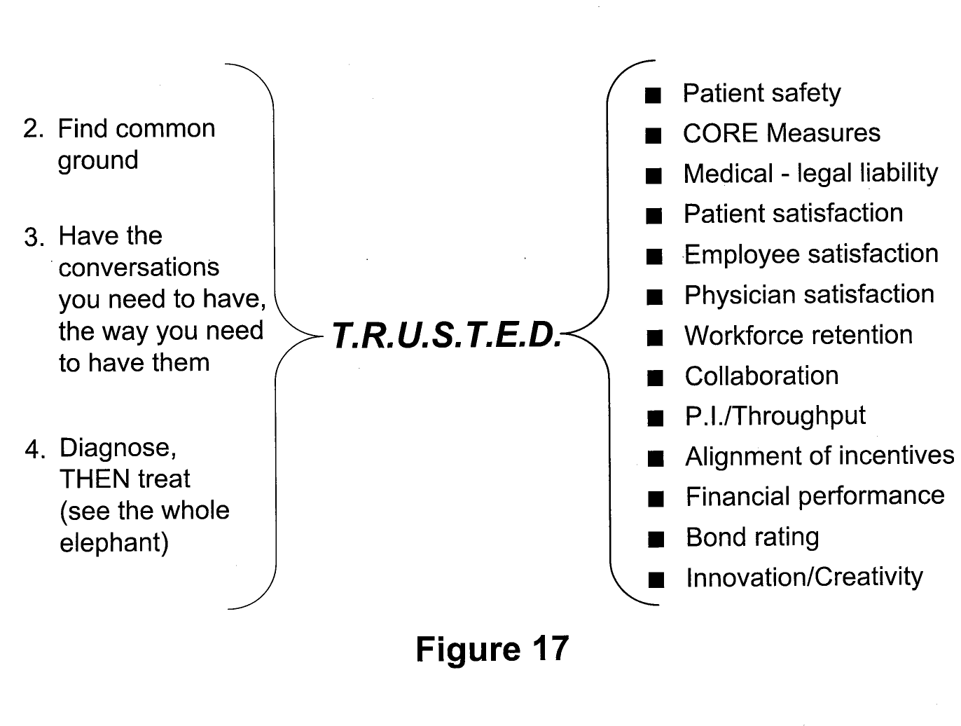

It may be beneficial to present a visual depiction of the lessons to the participants. Referring to FIG. 17, the second, third, and fourth lessons appear along the left hand side of the figure. Along the right hand side of the figure, a list of desired results for the organization are provided. The same list of desired results used in FIG. 16 may be used in FIG. 17. In the center of the figure, between the lessons and the desired results, the word “T.R.U.S.T.E.D.” is provided to illustrate that exhibition of the universal attributes is the root cause and therefore a root accelerator to obtaining the desired results. As will be explained below, the word “T.R.U.S.T.E.D.” is an acronym for a set of universal attributes presented to the participants. Herein, the universal attributes may be referred using the terms “T.R.U.S.T.E.D.” and “T.R.U.S.T.E.D. Colleagues.” In other words, exhibition of the universal attributes leads to the establishment of common ground, which leads to having successful crucial conversations, which leads to appropriate root cause diagnoses.

For some participants, the system 10′, which is characterized as building trust amongst members of an organization may be easier to comprehend than the system 10 (see FIG. 1), which is characterized as being based on profitability. Like the water cycle and the profitability cycle 800 (see FIG. 3), each portion of the cycle 1200 feeds into the next. The cycle 1200 may be analogized to the water cycle in the same manner the cycle 800 was analogized to the water cycle above.

The cycle 1200 includes four components: a first component 1210 that corresponds to exhibiting the universal attributes (which may be referred to as “T.R.U.S.T.E.D. Colleagues”), a second component 1220 that corresponds to reaching common ground, a third component 1230 that corresponds to having successful critical conversations, and a fourth component 1240 that corresponds to correctly diagnosing prior to initiating treatment. Because the cycle 1200 is based on establishing trust between members of the organization, one or more of the components 1210, 1220, 1230, and 1240 may be based on an acronym, such as “T.R.U.S.T.E.D.” that communicates and reinforces establishing trust.

The system 10′ may be constructed to provide rapid skill acquisition using the “see one, do one, teach one” methodology described above. The “see one” occurs during lectures. The “do one” occurs during the exercises. The “teach one” occurs back at the organization after the completion of the components 1210, 1220, 1230, and 1240. After the participants return to the organization, they are able to teach others the lessons of the system 10′. Before any of the components 1210, 1220, 1230, and 1240 are presented, the presenter(s) may present an overview of one or more of the components 1210, 1220, 1230, and 1240 to orient the participants.

While in the cycle 1200 illustrated in FIG. 15, the components 1210, 1220, 1230, and 1240 are arranged in a particular order, those of ordinary skill in the art understand that the order of the components 1210, 1220, 1230, and 1240 in the cycle 1200 may vary and one or more of the components may be omitted during a particular traversal of the cycle. Further, during the presentation of a particular component, introductions to one or more subsequent components may be provided. Traversing and repeating the cycle 1200 drives an organization toward the ideal state 1250 and away from the disaster state (not shown). Traversing and repeating the cycle 1200 may also improve trust between the participants and may mold them into colleagues that trust one another (“trusted colleagues”).

To achieve the first component 1210, which corresponds to teaching the participants to exhibit the universal attributes, all or a portion of the module 100 may be performed. For example, the system 10′ may perform the method 840 to obtain a description of each of the ideal state (block 844), the disaster state (block 846), the present state (block 848), and an individual's ability to influence the present state (block 850). Alternatively, the presenter(s) may present a description of the ideal state and a description of the disaster state. Then, the presenter(s) may assign a numerical value to each of the ideal state (e.g., 10) and the disaster state (e.g., 0). Then, the presenter(s) may ask the participants to rate the present state of the organization on a numerical scale ranging from the ideal state (e.g., 10) to the disaster state (e.g., 0).

Instead of or in addition to obtaining a description of an individual's ability to influence the present state, the presenter(s) may ask the participants to describe situations and behaviors occurring at the organization that are moving the present state of the organization toward the ideal state or the disaster state. The participants may be asked if they have observed the situations and/or behaviors at their organization. The group may then be asked if they believe the organization can move toward the ideal state and/or the disaster state. In other words, the presenter(s) may direct the group to analyze the ability of the organization and/or the members of the organization to change the present state.

Up to this point, the focus may be placed on the organization or the group instead of on the individual to depersonalize the exercise. Next, the participants may be asked how many of the behaviors moving the organization toward the disaster state they have exhibited themselves. In other words, the participants are asked whether they have observed the organizational behaviors in themselves. A goal of this portion of the system 10′ may include an appreciation on the part of the participants that a gap defined between the present state and the ideal state exists at both the organizational and interpersonal levels and further, that it is bridgeable and the ideal state is obtainable. Another goal may include an appreciation on the part of the participants that bridging the gap is within their control. Again, as in system 10, the participants gain awareness of their ability to affect the present state and move it toward the ideal state and away from the disaster state.

To achieve the second component 1220, which corresponds to reaching common ground, the participants are asked to prepare a list of universal group graffiti behaviors using any of the methods describe above with respect to the system 10. The participants may be asked to prepare a list of graffiti behaviors exhibited by or within the organization. Then, as discussed above, the participants may be asked to prepare a list of personal graffiti behaviors. Alternatively, a list of universal group graffiti behaviors may be presented by the presenter(s), who may ask the participants to validate or confirm that the predetermined set of graffiti behaviors are behaviors that the majority of the group agrees are undesirable and contribute to moving the organization toward the disaster state.

Instead of preparing a list of universal attributes, a predetermined set of universal attributes may be presented. Then, the participants may be asked to validate or confirm that the predetermined set of universal attributes are desirable behaviors that the majority of the group agrees describe a “best colleague.” The first letter of each of the predetermined set of universal attributes may form an acronym to make the list easier to remember. Further, the acronym may reinforce a desired result of exhibiting the predetermined set of universal attributes. For example, the following predetermined set of universal attributes may be presented, the first letter of each of these universal attributes spelling the acronym “T.R.U.S.T.E.D.:”

Team player;

Responsive and respectful;

Understanding (listens and learns without passing judgment);

Safe (easy to approach and asks for opinions);

Talented (skilled, knowledgeable, good judgment, proficient, etc.);

Execution (gets things done; gets results); and

Dedicated and devoted (exhibits a good work ethic).

Because the last three of the above universal attributes (talented, execution, and dedicated) are common attributes among professionals, aspects of the system 10′ may focus on the first four universal attributes. Further, the first four universal attributes involve skills beyond those typically provided by professional education and training.

Optionally, a list of undesired characteristics or behaviors (e.g., the graffiti behaviors) may also be presented. By way of a non-limiting example, the list of undesired characteristics or behaviors may include rigid, inflexible, poor listener, disrespectful, arrogant, intimidating, threatening, judgmental, unforgiving, and the like. Alternatively, the participants may develop the list of graffiti behaviors using any technique described above with respect to block 884 and/or block 886 of the method 860 depicted in FIG. 5. In particular embodiments, the participants may develop the list of graffiti behaviors before the universal attributes are presented.

The participants may be asked to perform a rating exercise during which they evaluate the effect of the universal attributes on a list of desired results. By way of a non-limiting example, the list of desired results in FIG. 16 or FIG. 17 may be used. The participants may be asked to rate the effect of each of the universal attributes on each of the desired results using a predetermined scale. For example, the scale may range from a minimum value (e.g., −5) to a maximum value (e.g., 5). A larger rating value may indicate a more positive effect on the desired result than a smaller rating value.

During the rating exercise, the participants may be asked to rate the effect of each of the undesired characteristics or behaviors on each of the desired results using the predetermined scale. Typically, the participants will assign lower ratings to the undesired characteristics or behaviors and higher ratings to the universal attributes. These evaluations demonstrate to the participants that the universal attributes move the organization closer to the ideal state and the undesired characteristics or behaviors move the organization further from the ideal state.

The rating exercise illustrates that mistrust (exacerbated by graffiti) is the root cause of problems and that trust (through becoming a TRUSTED colleague) is the root solution. Also, when both graffiti behaviors and the universal attributes are present, they tend to neutralize each other, which further emphasizes the need to eliminate the undesired behaviors, as much as possible.

Next, instead of creating the declaration 910 (see FIG. 7A), a chart substantially similar to the chart 920 depicted in FIG. 8 may be presented to the participants. However, instead of asking the participants to provide “gets” and “gives,” the description of the ideal state and the universal attributes may be listed as the “gets” (i.e., what the participants want) and the description of the disaster state and graffiti behaviors may be listed as the “gives up” (i.e., what the participants are willing to give to get the items the participants want). Then, instead of assent to or acceptance of the declaration 910, the participants may be asked for a commitment to eliminate the graffiti behaviors and accentuate or exhibit the universal attributes.

To achieve the third component 1230, which corresponds to having successful critical conversations, the presenter(s) may lecture the participants with respect to how to conduct difficult or crucial conversations with others. Successful critical conversations are robust conversations conducted with the utmost personal safety. Then, a role playing exercise is conducted in which the participants are presented with a familiar scenario in which a crucial conversation must occur and must be conducted successfully. For example, the following fact pattern may be presented to a group of participants including medical professionals:
A patient is brought to the organization (e.g., hospital, clinic, etc.) after hours to the emergency department. The patient has congestive heart failure, diabetes, and peripheral vascular disease. His leg hurts and is cold and dusky. The emergency department physician concludes the patient needs to be admitted for emergency surgery. The patient's primary care physician and the vascular surgeon agree. All operating rooms are full and the emergency department is packed. Before surgery, the patient needs at least the following: laboratory work; admission paperwork; a cardiology consult; a chest X-ray; an available room; a clean room; an initial nursing assessment; and an available operating room. Everyone responsible for these items is in a grumpy mood.

The participants are divided into groups. One of the participants in each group takes the role of a night shift supervisor who must place several calls to make sure these important tasks are all completed in time. At least one of the other participants in each group takes the role of a person responsible for providing something needed by the patient (e.g., laboratory work, admission paperwork, cardiology consult, chest X-ray, etc.)

During the role-playing exercise, the participants are first asked to conduct the conversation in a manner that “does not go well.” Without further instruction, the participants conduct the conversation. The conversations may be limited to a predetermined duration (e.g., 2 minutes). After the first conversation, the participants are asked a series of questions to emphasize the ineffectiveness of the conversation. For example, the participants may be asked one or more of the following questions:
1. Was it real?
2. How did it feel?
3. Were you on one team, or acting as two separate groups?
4. Did you give and get respect?
5. Did you listen to and/or understand your counterpart?
6. Did you make the conversation safe for each other?
7. Were you building TRUST with each other?
8. Was the conversation productive or efficient?
9. Were you innovative or creative?
10. Did you help the patient?

In response to the first two questions, the participants will typically respond that the conversation felt real but did not feel good. Negative responses are typically given to the remaining eight questions.

Next, the participants are asked to repeat the conversation but this time, before responding to one another, they are instructed to pause (e.g., take a breath), and, in the words of Dr. Viktor Frankl, to literally create their own space between stimulus and response and then to provide a different response from the one provided in the conversation that did not go well. Without further instruction, the participants conduct the conversation. In other words, the lessons of Dr. Frankl's teachings (discussed above) may be applied without explicitly presenting his teachings. The second conversation may be limited to a shorter predetermined duration (e.g., 90 seconds) than the predetermined duration (e.g., 2 minutes) of the first conversations. The length of the shorter predetermined duration may not be disclosed to the participants who are likely to assume the same duration has been provided for both conversations. After the second conversation, the participants are asked a series of questions to emphasis the effectiveness of the conversation.

By way of a non-limiting example, the same questions asked after the first conversation may be repeated after the second conversation. In response to the first two questions, the participants will typically respond that the conversation felt real and felt better than the first conversation. Positive responses are typically given to the remaining eight questions. Finally, the fact that less time was provided for the second conversation is revealed to the participants to emphasize the efficiency and effectiveness of pausing before responding.

The dialogue model 1000 and the modified dialogue model 1000′ may be presented. In the modified dialogue model 1000′ the layer 1020A may be labeled “Fight” and “Flight.” The layer 1020C may be labeled “Personal Safety.” Further, if the participants are medical professionals, the center layer 1020D may be labeled “best place to practice, work, and get care.” The dialogue model 1000 and the modified dialogue model 1000′ may be presented in the manner described above.

A crucial conversation conducted in one or more movie clips may be presented and discussed. By way of a non-limiting example, scenes 6, 7, and 8 from the movie Gettysburg may be presented and discussed in the manner described above. For each “moment of truth,” the participants may be asked to provide example responses that would be in accordance with the universal attributes and responses that would be in accordance with the graffiti behaviors. Further, each “moment of truth” may be discussed with respect to each of the universal attributes.

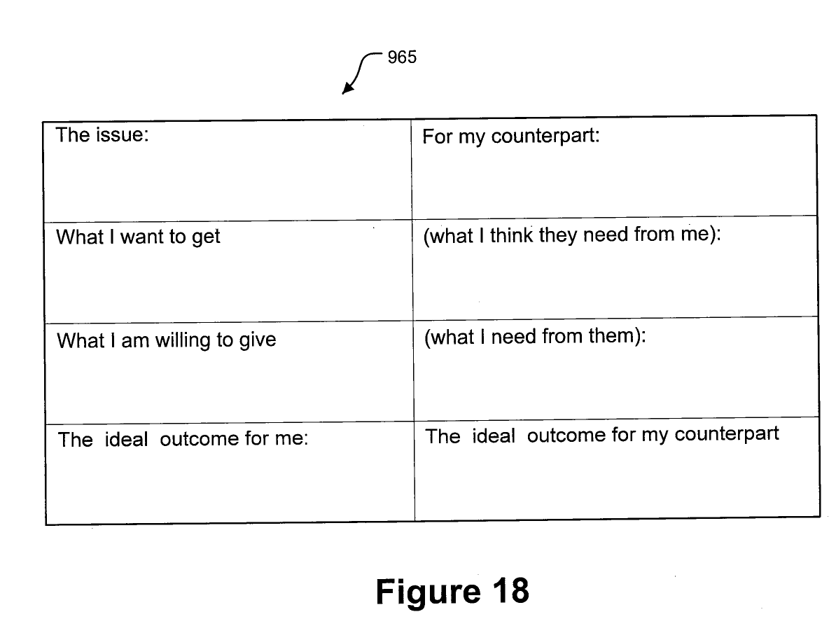

Each participant may be asked to select a compassionate conversation he/she needs to have with someone inside the organization. This conversation should have a high degree of difficulty. For example, a future conversation that a participant fears or dreads the most may be selected. The conversation selected should be important and its success should be necessary. In other words, the participants are told to select a conversation that must “go well.” The participants may be given a worksheet to help them frame the important issues of the conversation. Referring to FIG. 18, a non-limiting example of a worksheet 965 is provided. When completing the worksheet 965, the participants may be asked to consider a set of service standards. The service standards may include safety, courtesy/compassion, presentation and efficiency, and the universal attributes. The worksheet 965 may be shared with others in a small group who may provide feedback and assist with completing the worksheet. Then, these conversations may be practiced (role-played) in the same manner discussed above with respect to the “do one” portion of block 966 depicted in FIG. 9B.

The fourth component 1240 may be characterized as “seeing the whole elephant,” which is a reference to a story in which blind men each touch a different portion of an elephant and describe the elephant as having completely different properties. The story teaches that reality may be viewed differently depending upon the perspective of the observer. Only by viewing the whole elephant (which includes the combination of the separate properties, each of which describes a portion of the elephant) can one see the whole elephant.

To achieve the fourth component 1240, which corresponds to diagnosing and then treating, blocks 1052 and 1054 of the method 1050 (see FIG. 13) are performed to obtain a prioritized list of barriers. Then, block 1060 is performed. In block 1060, the participants plan how they will adapt their environment by removing the barriers. Optionally, the participants may be asked to take the oath promising to work toward exhibiting the universal attributes.

The focus of the fourth component 1240 is identifying a root cause of a problem and then addressing the cause. This mirrors the focus of the system 10′, which addresses an undesirable working environment by addressing lack of trust between members of the organization (i.e., people working in the undesirable working environment). Specifically, the system 10′ addresses a root cause of poor workplace environments, namely undesirable behavior. The system 10′ further addresses a root cause of undesirable workplace behavior, namely, a lack of trust between members of the organization.

If the cycle 1200 is understood and mastered by the members of a healthcare organization, that healthcare organization may create and increase trust locally. This increased trust may improve measures of organizational performance (as well as indicators of personal fulfillment). In this manner, the TRUST Cycle 1200 including its (T.R.U.S.T.E.D. Colleagues) universal attributes provide a “root solution” to many of the problems in healthcare.

The cycle 1200 may be viewed as a unifying framework that teaches four “lifetime leadership lessons” that physicians (and other healthcare professionals) were never taught. One or more of the components 1210, 1220, 1230, and 1240 that teach these lessons may be repeated and used to solve many previously unsolvable interpersonal, group, or system problems in the organization.

The first lifetime lesson, which is taught during the first component 1210, may be characterized as “Harnessing the power of “T.R.U.S.T.E.D. Colleagues.” In this lesson, the participants deconstruct and understand trust as a constellation of key, universal attributes and behaviors that simultaneously earn trust for an individual while creating an environment of trust within a group. The first lesson also teaches participants to understand the profound impact of their own behavior, both positive and negative, on their role as healers, leaders, and role models. Further, during the first lesson, the participants learn to control their collective destiny in the “space between stimulus and response.”

As mentioned previously, the second lifetime lesson, which is taught during the second component 1220, may be characterized as “Finding common ground.” During this lesson, the participants define what they want and what they do not as a group collectively. The participants also discover the power of focusing on the things that unite the group instead of the things that make each individual in the group unique.

The third lifetime lesson, which is taught during the third component 1230, may be characterized as “Safe Conversations.” This lesson includes learning to have the conversations the participants need to have, in the way they need to have them. Further, the participants acquire the skills to create a safe environment in their daily, interpersonal relationships. They may also learn to understand the powerful impact of “personal safety” on aspects of the working environment at the organization. For example, they may learn the impact of “personal safety” on patient safety, clinical quality, patient satisfaction, employee/physician engagement, operational efficiency, professional fulfillment, and the like.

The fourth lifetime lesson, which is taught during the fourth component 1240, may be characterized as “Seeing the whole elephant.” This lesson includes learning to make the correct, unifying diagnosis, before starting treatment, especially in the context of unit, interdisciplinary, and system-wide process improvement.

While the system 10 and system 10′ have been described with respect to participants that are physicians, the systems have been found to be effective for all other key stakeholders. Thus, whether the participants are physicians, nurses, other allied health professionals, hospital staff, hospital management, executive leadership, volunteers, board members, or any combination of these, the approaches of the systems 10 and 10′ have been found to be extremely effective. That is to say, the same approach can be applied, “from bedside to boardroom” in any organization, in any location with a variety of different stakeholders, as a universal method.

Using radiologists and an example, the participants may include one or more of the following members of one or more organizations:
Radiologists only;
Radiologists and other members of an imaging interdisciplinary team;
Radiologists and physicians from other departments (e.g. pathology, anesthesiology, ED, hospitalists, and the like) practicing different specialties; and
Imaging interdisciplinary team members and team members from other interdisciplinary teams from other departments.

In particular embodiments, the system 10 and system 10′ may each be presented in about eight hours. For example, the system 10 or system 10′ may be presented during a weekend retreat during which content is presented Friday afternoon and Saturday morning. Alternatively, the system 10 or system 10′ may be presented during two to three evening sessions, each having a duration of about 3 hours to 4 hours. By way of another example, the system 10 or system 10′ may be presented during one eight hour session.

One or more lessons may be repeated or homework may be presented and/or discussed during one or more follow up sessions. By way of an example, a follow up session may be about two hours to about four hours in duration. In some embodiments, a follow up session may be provided in response to a request received from one or more participants or from one or more organizations.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method of training each participant within a plurality of participants to function individually within an organization having a functional purpose, each participant of the plurality of participants belonging to the organization, and the plurality of participants performing the method together as a group, the method comprising:
developing a first description of a desired state of the organization in which the organization is able to at least partially achieve its functional purpose, the desired state being more desirable than a present state of the organization;
developing a second description of an undesired state of the organization in which the organization is less able to at least partially achieve its functional purpose, the undesired state being less desirable than the present state of the organization;
evaluating the present state of the organization to determine whether it is closer to the desired state or the undesired state;
evaluating an ability of a participant to modify the present state of the organization moving the present state toward one of the desired state and the undesired state;
validating a list of universal attributes comprising a list of desirable behaviors for a member of the organization;
developing a list of graffiti behaviors comprising a list of undesirable behaviors for a member of the organization; and
providing a commitment to try to exhibit at least a portion of the behaviors on the list of desirable behaviors of the list of universal attributes and to forgo at least a portion of the behaviors on the list of undesirable behaviors of the list of graffiti behaviors.

2. The method of claim 1, further comprising:
receiving a fact pattern including a conversation having at least two roles;
being assigned one of the at least two roles, the other of the at least two roles being assigned to another of the plurality of participants;
role-playing the conversation in a manner that renders the conversation ineffective, the role play including a response;
repeating the role-play of the conversation; and
during the repeated role-play, pausing before providing the response and providing a different response than the response provided during the previous role play.

3. The method of claim 1, wherein providing the commitment comprises:
developing a compact comprising a description of a desirable environment within the organization, a list of behaviors the participants agree they would be willing to exhibit in exchange for the realization of the desirable environment within the organization, and a list of behaviors the participants agree they would be willing to forego in exchange for the realization of the desirable environment within the organization, the list of behaviors the participants would be willing to forego comprising the portion of the desirable behaviors on the list of graffiti behaviors, and the list of behaviors the participants would be willing to exhibit comprising the portion of the undesirable behaviors on the list of universal attributes; and
indicating acceptance of the compact.

4. The method of claim 1, further comprising:
obtaining a single description of agreed upon characteristics of a satisfactory team experience;
evaluating the characteristics of a satisfactory team experience in view of the universal attributes; and
defining a desirable team as being composed of members exhibiting the universal attributes.

5. The method of claim 1, further comprising:
receiving an explanation of a dialogue model;
receiving an explanation of the dialogue model modified to include the list of universal attributes, the list of graffiti behaviors, the desired state, and the undesired state;
selecting an actual feared or dreaded future conversation;
dividing the group into a plurality of subgroups; and
within each subgroup of the plurality of subgroups, role playing the feared or dreaded conversation.

6. The method of claim 1, further comprising:
receiving an explanation of a dialogue model;
receiving an explanation of the dialogue model modified to include the list of universal attributes, list of graffiti behaviors, desired state, and undesired state;
dividing the group into a plurality of subgroups;
within each subgroup of the plurality of subgroups, role playing a plurality of practice conversations; and
creating a plan to have a predetermined number of conversations at least one of which being based on one of the plurality of practice conversations.

7. The method of claim 1, wherein developing the list of graffiti behaviors comprises:
as a group, developing a first list of graffiti behaviors comprising a list of undesirable group behaviors for the members of the organization; and
as a group, developing a second list of graffiti behaviors comprising a list of undesirable personal behaviors of the members of the organization.

8. The method of claim 1, further comprising developing the list of universal attributes.

9. The method of claim 8, wherein developing the list of universal attributes comprises describing the desirable behaviors of a best colleague.

10. The method of claim 1, wherein evaluating the ability of the participant to modify the present state of the organization moving the present state toward one of the desired state and the undesired state comprises:
evaluating the effect of the undesirable behaviors on the list of graffiti behaviors on the present state and the effect of the desirable behaviors on the list of universal attributes on the present state; determining whether the undesirable behaviors on the list of graffiti behaviors move the present state closer to the undesired state and the desirable behaviors on the list of universal attributes move the present state closer to the desired state, and
determining whether the undesirable behaviors move the present state by a larger amount than the desirable behaviors.

11. The method of claim 1, further comprising:
evaluating the effect of the undesirable behaviors on the list of graffiti behaviors on the present state; and
determining whether the undesired state is a result of the exhibition of the list of undesirable behaviors on the list of graffiti behaviors by at least a portion of the organization.

12. The method of claim 1, further comprising:
evaluating the effect of the desirable behaviors on the list of universal attributes on the present state; and
determining whether the desired state is a result of the exhibition of the list of desirable behaviors on the list of universal attributes by at least a portion of the organization.

13. The method of claim 1, further comprising:
evaluating the effect of the desirable behaviors on the list of universal attributes on the present state; and
determining whether the desired state is a result of the exhibition of the list of desirable behaviors on the list of universal attributes by a majority portion of the organization.

14. The method of claim 1, further comprising:
evaluating the effect of the desirable behaviors on the list of universal attributes on the present state; and
determining whether the desirable environment within the organization is a result of the exhibition of the list of desirable behaviors on the list of universal attributes by at least a portion of the organization.

15. The method of claim 1, further comprising:
evaluating a result of the exhibition of a behavior on the list of desirable behaviors on the list of universal attributes;
determining whether the exhibition of the behavior on the list of desirable behaviors on the list of universal attributes is more likely to cause others to exhibit a behavior on the list of desirable behaviors of the list of universal attributes than to exhibit a behavior on the list of undesirable behaviors of the list of graffiti behaviors;
evaluating a result of the exhibition of a behavior on the list of undesirable behaviors on the list of graffiti behaviors; and
determining whether the exhibition of the behavior on the list of undesirable behaviors on the list of graffiti behaviors is more likely to cause others to exhibit a behavior on the list of undesirable behaviors on the list of graffiti behaviors than to exhibit a behavior on the list of desirable behaviors on the list of universal attributes.

16. The method of claim 1, further comprising:
identifying barriers in the organization to exhibiting the list of desirable behaviors on the list of universal attributes;
prioritizing the barriers identified; and
using the prioritization of the barriers to create a plan to reduce or remove those barriers thereby adapting the organization to facilitate the exhibition of the desirable behaviors on the list of universal attributes.

17. The method of claim 1, further comprising:
identifying accelerators in the organization that facilitate the exhibition of the list of desirable behaviors on the list of universal attributes;
prioritizing the accelerators identified; and
using the prioritization of the accelerators to create a plan to promote or enhance those accelerators thereby adapting the organization to facilitate the exhibition of the desirable behaviors on the list of universal attributes.

18. A method of addressing behavioral problems within a selected organization that interfere with its performance of its functional purpose, the method comprising:
creating a group of group members comprising at least one member of the selected organization and a plurality of members of at least one different organization that is experiencing behavioral problems by its members that interfere with its performance of its functional purpose;
directing the group to develop a single first description of a desired state in which both the selected organization and the at least one different organization would be able to at least partially perform their respective functional purposes, the desired state being more desirable than a first present state of the selected organization and a second present state of the at least one different organization;
directing the group to develop a single second description of an undesired state in which both the selected organization and the at least one different organization would be less able to at least partially perform their respective functional purposes, the undesired state being less desirable than the first present state of the selected organization and the second present state of the at least one different organization;
directing the group to evaluate an ability of a set of behaviors exhibited by a member of the selected organization and a member of the at least one different organization to move the first present state of the selected organization and the second present state of the at least one different organization, respectively, toward the desired state;
directing the group to validate a single list of universal attributes comprising a list of desirable behaviors for a member of the selected organization and a member of the at least one different organization;
directing the group to develop a single list of graffiti behaviors comprising a list of undesirable behaviors for a member of the selected organization and a member of the at least one different organization; and
obtaining from the at least one member of the selected organization and the plurality of members of the at least one different organization an indication of agreement to exhibit at least a portion of behaviors on the list of desirable behaviors of the single list of universal attributes and to forgo at least a portion of behaviors on the list of undesirable behaviors of the single list of graffiti behaviors.

19. The method of claim 18, wherein obtaining the indication of agreement from the at least one member of the selected organization and the plurality of members of the at least one different organization comprises:
directing the group to develop a single compact comprising:
a description of a desirable environment within the selected organization and the at least one different organization,
the portion of behaviors on the list of desirable behaviors of the single list of universal attributes, and
the portion of behaviors on the list of undesirable behaviors of the single list of graffiti behaviors, the compact comprising a promise to exhibit the portion of behaviors on the list of desirable behaviors of the single list of universal attributes and to forgo the portion of behaviors on the list of undesirable behaviors of the single list of graffiti behaviors in exchange for the realization of the desirable environment within the selected organization and the at least one different organization; and
obtaining an indication of acceptance of the compact by the at least one member of the selected organization and the plurality of members of the at least one different organization.

20. The method of claim 18, further comprising:
directing the group to develop a single description of agreed upon characteristics of a satisfactory team experience; and
directing the group to evaluate the characteristics of a satisfactory team experience in view of the universal attributes.

21. The method of claim 18, further comprising:
presenting to the group an explanation of the dialogue model;
presenting to the group an explanation of the dialogue model modified to include the list of universal attributes, list of graffiti behaviors, desired state, and undesired state;
directing the at least one member of the selected organization to create a list of practice conversations having varying levels of difficulty;
directing the at least one member of the selected organization to role-play at least one of the practice conversations on the list with at least one of the other group members; and
directing the at least one member of the selected organization to create a plan to have a predetermined number of conversations at least one of which is based on the at least one practice conversation.

22. The method of claim 18, further comprising:
presenting to the group an explanation of the dialogue model;
presenting to the group an explanation of the dialogue model modified to include the list of universal attributes, the list of graffiti behaviors, the desired state, and the undesired state;
directing the at least one member of the selected organization to select an actual future conversation the at least one member plans to have in the future; and
directing the at least one member of the selected organization to role-play the future conversation with at least one of the other group members.

23. The method of claim 18, further comprising:
presenting to the group a fact pattern including a conversation having at least two roles;
assigning one of the at least two roles to the at least one member of the selected organization;
assigning another of the at least two roles to at least one of the other group members;
directing the at least one member of the selected organization and the at least one of the other group members to role-play the conversation in a manner that renders the conversation ineffective, the role play including a response; and
directing the at least one member of the selected organization and the at least one of the other group members to repeat the role-play of the conversation, further directing the at least one member of the selected organization and the at least one of the other group members during the repeated role-play, to pause before providing the response and provide a different response than the response provided during the previous role play.

24. The method of claim 18, wherein directing the group to develop the list of graffiti behaviors comprises:
directing the group to develop a first list of graffiti behaviors comprising a list of undesirable group behaviors for the selected organization and the at least one different organization; and
directing the group to develop a second list of graffiti behaviors comprising a list of undesirable personal behaviors of the group members.

25. The method of claim 18, further comprising:
directing the group to develop the single list of universal attributes comprising the list of desirable behaviors for the member of the selected organization and the member of the at least one different organization.

26. The method of claim 25, wherein directing the group to develop the list of universal attributes includes directing the group to develop the list of universal attributes by describing the desirable behaviors of a best colleague.

27. The method of claim 18, further comprising:
directing the group to identify barriers present in both the selected organization and the at least one different organization to exhibiting the list of desirable behaviors on the list of universal attributes;
directing the group to prioritize the barriers; and
directing the group to use the prioritization of the barriers to create a plan to reduce or remove those barriers thereby adapting the selected organization and the at least one different organization to facilitate the exhibition of the desirable behaviors on the list of universal attributes.

28. The method of claim 18, further comprising:
directing the group to identify accelerators present in both the selected organization and the at least one different organization that facilitate the exhibition of the list of desirable behaviors on the list of universal attributes;
directing the group to prioritize the accelerators identified; and
directing the group to use the prioritization of the accelerators to create a plan to promote or enhance those accelerators thereby adapting the selected organization and the at least one different organization to facilitate the exhibition of the desirable behaviors on the list of universal attributes.

29. A method of obtaining a compact from a plurality of members of an organization having a present working environment, the compact comprising a promise from each of members of the plurality of members to exhibit behavior that will improve the working environment of the organization, the method comprising from the plurality of members:
obtaining a description of the improved working environment;
obtaining a description of a deteriorated working environment;
obtaining an evaluation of an ability of individual behavior to influence the present working environment toward one of the improved working environment and the deteriorated working environment;
obtaining a list of desirable behaviors and a list of undesirable behaviors;
using the evaluation of the ability of individual behavior to influence the working environment to develop the compact comprising a promise to forego behaviors on the list of undesirable behaviors and to exhibit behaviors on the list desirable behaviors thereby promising to influence the present working environment toward the improved working environment; and
obtaining an indication of acceptance of the compact.

30. A method of addressing behavioral problems within a selected organization that interfere with its performance of its functional purpose, the method comprising:
creating a group of group members comprising at least one member of the selected organization;
directing the group to develop a single first description of a desired state in which the selected organization would be able to at least partially perform its respective functional purposes, the desired state being more desirable than a present state of the selected organization;
directing the group to develop a single second description of an undesired state in which the selected organization would be less able to at least partially perform its respective functional purposes, the undesired state being less desirable than the present state of the selected organization;
directing the group to evaluate an ability of a set of behaviors exhibited by a member of the selected organization to move the first present state of the selected organization toward the desired state;
directing the group to validate a single list of universal attributes comprising a list of desirable behaviors for a member of the selected organization;
directing the group to develop a single list of graffiti behaviors comprising a list of undesirable behaviors for a member of the selected organization; and
obtaining from the at least one member of the selected organization an indication of agreement to exhibit at least a portion of behaviors on the list of desirable behaviors of the single list of universal attributes and to forgo at least a portion of behaviors on the list of undesirable behaviors of the single list of graffiti behaviors.

31. The method of claim 30, further comprising:
presenting to the group an explanation of the dialogue model;
presenting to the group an explanation of the dialogue model modified to include the list of universal attributes, the list of graffiti behaviors, the desired state, and the undesired state;
directing the at least one member of the selected organization to select an actual future conversation the at least one member plans to have in the future; and
directing the at least one member of the selected organization to role-play the future conversation with at least one of the other group members.

32. The method of claim 30, further comprising:
directing the group to identify barriers present in the selected organization to exhibiting the list of desirable behaviors on the list of universal attributes;
directing the group to prioritize the barriers; and
directing the group to use the prioritization of the barriers to create a plan to reduce or remove those barriers thereby adapting the selected organization to facilitate the exhibition of the desirable behaviors on the list of universal attributes.

33. The method of claim 30, further comprising:
directing the group to identify accelerators present in the selected organization that facilitate the exhibition of the list of desirable behaviors on the list of universal attributes;
directing the group to prioritize the accelerators identified; and
directing the group to use the prioritization of the accelerators to create a plan to promote or enhance those accelerators thereby adapting the selected organization to facilitate the exhibition of the desirable behaviors on the list of universal attributes.
